(19) United States
(12) Patent Application Publication
(10) Pub. No.: US 2011/0317177 A1
(43) Pub. Date: Dec. 29, 2011

(54) IMAGE PROCESSING APPARATUS, IMAGE PROCESSING METHOD, AND RECORDING APPARATUS

(75) Inventors: Norihiro Kawatoko, Yokohama-shi (JP); Hitoshi Nishikori, Inagi-shi (JP); Yutaka Kano, Yokohama-shi (JP); Yuji Konno, Kawasaki-shi (JP); Akitoshi Yamada, Yokohama-shi (JP); Mitsuhiro Ono, Tokyo (JP); Tomokazu Ishikawa, Yokohama-shi (JP)

(73) Assignee: CANON KABUSHIKI KAISHA, Tokyo (JP)

(21) Appl. No.: 13/163,598

(22) Filed: Jun. 17, 2011

(30) Foreign Application Priority Data
Jun. 24, 2010 (JP) 2010-144212

(51) Int. Cl. G06K 15/10

(52) U.S. Cl. 358/1.5

(57) ABSTRACT

An image processing apparatus includes a first generation unit configured to generate N pieces of same color multi-valued image data, a second generation unit configured to generate N pieces of quantized data by performing quantization processing on the N pieces of same color multi-valued image data, and a third generation unit configured to divide at least one piece of the N pieces of quantized data into a plurality of quantized data and generate M pieces of quantized data corresponding to the M relative movements. The M pieces of quantized data includes quantized data corresponding to an edge portion of the recording element group and quantized data corresponding to a central portion of the recording element group, and a recording duty of the quantized data corresponding to the edge portion is set lower than a recording duty of the quantized data corresponding to the central portion.

### BACKGROUND OF THE INVENTION

1. Field of the Invention

The present invention relates to an image processing apparatus, an image processing method, and a recording apparatus, which can process input image data corresponding to an image to be recorded in a predetermined area of a recording medium through a plurality of relative movements between a recording unit including a plurality of recording element groups and the recording medium.

2. Description of the Related Art

As an example of a recording method using a recording head equipped with a plurality of recording elements to record dots, an inkjet recording method for discharging an ink droplet from a recording element (i.e., a nozzle) to record a dot on a recording medium is conventionally known. In general, inkjet recording apparatuses can be classified into a full-line type or a serial type according to their configuration features. In each of the full-line type and the serial type, a dispersion (or error) in discharge amount or in discharge direction may occur between two or more recording elements provided on the recording head. Therefore, a recorded image may contain a defective part, such as an uneven density or streaks, due to the above-described dispersion (or error).

A multi-pass recording method is conventionally known as a technique capable of reducing the above-described uneven density or streaks. The multi-pass recording method includes dividing image data to be recorded in the same area of a recording medium into image data to be recorded in a plurality of scanning and recording operations. The multi-pass recording method further includes sequentially recording the above-described divided image data through a plurality of scanning and recording operations of the recording head performed together with intervening conveyance operations of the recording medium. Thus, even if any dispersion (or error) is contained in discharge characteristics of individual recording elements, dots recorded by the same recording element are not continuously disposed in the scanning direction, and the influence of individual recording elements can be decentralized in a wide range. As a result, it becomes feasible to obtain an even and smooth image.

The above-described multi-pass recording method can be applied to a serial type (or a full-multi type) recording apparatus that includes a plurality of recording heads (i.e., a plurality of recording element groups) configured to discharge a same type of ink. More specifically, the image data is divided into image data to be recorded by a plurality of recording element groups that discharges the above-described same type of ink. Then, the divided image data are recorded by the above-described plurality of recording element groups during at least one relative movement. As a result, the multi-pass recording method can reduce the influence of a dispersion (or error) that may be contained in the discharge characteristics of individual recording elements. Further, if the above-described two recording methods are combined, it is feasible to record an image with a plurality of recording element groups each discharging the same type of ink while performing a plurality of scanning and recording operations.

Conventionally, a mask pattern including dot recording admissive data (1: data that does not mask image data) and dot recording non-admissive data (0: data that masks image data) disposed in a matrix pattern can be used in the division of the above-described image data. More specifically, binary image data can be divided into binary image data to be recorded in each scanning and recording operation or by each recording head based on AND calculation between binary image data to be recorded in the same area of a recording medium and the above-described mask pattern.

In the above-described mask pattern, the layout of the recording admissive data (1) is determined in such a way as to maintain a mutually complementary relationship between a plurality of scanning and recording operations (or between a plurality of recording heads). More specifically, if performing recording with binarized image data is designated for a concerned pixel, one dot is recorded in either one of the scanning and recording operations or by any one of the recording heads. Thus, it is feasible to store image information before and after the division of the image data.

However, a problem newly arises when the above-described multi-pass recording operation is performed. For example, a density change or an uneven density may occur due to a deviation in recording position (i.e., registration) of each scanning and recording operation or each recording head (i.e., each recording element group).

In this case, the deviation in recording position of each scanning and recording operation or each recording element group indicate the following content. More specifically, for example, in a case where one dot group (i.e., one plane) is recorded in the first scanning and recording operation (or by one recording element group) and another dot group (i.e., another plane) is recorded in the second scanning and recording operation (or by another recording element group), the deviation in recording position represents a deviation between two dot groups (planes).

The deviation between these planes may be induced by a variation in the distance between a recording medium and a discharge port surface (i.e., the head-to-sheet distance) or by a variation in the conveyance amount of the recording medium. If any deviation occurs between two planes, a corresponding variation occurs in the dot covering rate and a recorded image may contain a density variation or an uneven density. In the following description, the dot group (or a pixel group) to be recorded by the same unit (e.g., a recording element group that discharges the same type of ink) in the same scanning and recording operation is referred to as a “plane”, as described above.

As described above, to satisfy the recent need for high quality images, an image data processing method capable of suppressing the adverse influence of a deviation in recording position between planes that may occur due to variations in various recording conditions is required for a multi-pass recording operation. In the following description, the durability to any density variation or any uneven density that may occur due to a deviation in recording position between planes is referred to as “robustness.”

As discussed in U.S. Pat. No. 6,551,143 and in Japanese Patent Application Laid-Open No. 2001-150700, there are image data processing methods capable of enhancing the robustness. According to the above-described patent literatures, a variation in image density induced by variations in various recording conditions possibly occurs if binary image data is separated in such a way as to correspond to different scanning and recording operations or different recording element groups and the separated image data are mutually in a complementary relationship.

Therefore, a multi-pass recording operation excellent in “robustness” can be realized by generating the image data corresponding to different scanning and recording operations or different recording element groups in such a way as to lessen the above-described complementary relationship. Further, to prevent an image from containing a large density variation even in a case where a deviation occurs between a plurality of planes, the image data processing methods according to the above-described literatures include dividing multi-valued image data to be binarized in such a way as to correspond to different scanning and recording operations or different recording element groups and then binarizing the divided multi-valued image data independently.

FIG. 10 is a block diagram illustrating an image data processing method discussed in U.S. Pat. No. 6,551,143 or in Japanese Patent Application Laid-Open No. 2001-150700, in which multi-valued image data is distributed for two scanning and recording operations.

The image data processing method includes inputting multi-valued image data (RGB) 11 from a host computer and performing palette conversion processing 12 for converting the input image data into multi-valued density data (CMYK) corresponding to color inks equipped in a recording apparatus. Further, the image data processing method includes performing gradation correction processing 13 for correcting the gradation of the multi-valued density data (CMYK). The image data processing method further includes the following processing to be performed independently for each of black (K), cyan (C), magenta (M), and yellow (Y) colors.

More specifically, the image data processing method includes image data distribution processing 14 for distributing the multi-valued density data of each color into first scanning multi-valued data 15-1 and second scanning multi-valued data 15-2. For example, when the multi-valued image data of the black color has a value of “200”, a half of the above-described value, i.e., 100 (=200/2), is distributed to the first scanning operation. Similarly, the same value “100” is distributed to the second scanning operation. Subsequently, the first scanning multi-valued data 15-1 is quantized by first quantization processing 16-1 according to a predetermined diffusion matrix and converted into first scanning binary data 17-1, and finally stored in a first scanning band memory.

On the other hand, the second scanning multi-valued data 15-2 is quantized by second quantization processing 16-2 according to a diffusion matrix different from the first quantization processing and converted into second scanning binary data 17-2 and finally stored in a second scanning band memory.

In the first scanning and recording operation and the second scanning and recording operation, inks are discharged according to the binary data stored in respective band memories. According to the example method illustrated in FIG. 10, an image data is distributed to two scanning and recording operations. Alternatively, it is feasible to distribute an image data to two recording heads (two recording element groups), as discussed in U.S. Pat. No. 6,551,143 or in Japanese Patent Application Laid-Open No. 2001-150700.

FIG. 6A illustrates an example layout of black dots 1401 recorded in the first scanning and recording operation and white dots 1402 recorded in the second scanning and recording operation, in a case where mask patterns having a mutually complementary relationship are used to divide image data. In this case, density data of “255” is input to all pixels. For each pixel, a dot is recorded in either the first scanning and recording operation or the second scanning and recording operation. More specifically, the layout of respective dots is determined in such a manner than the dot to be recorded in the first scanning and recording operation does not overlap with the dot to be recorded in the second scanning and recording operation.

On the other hand, FIG. 6B illustrates another dot layout in a case where image data is distributed according to the above-described method discussed in U.S. Pat. No. 6,551,143 or Japanese Patent Application Laid-Open No. 2001-150700. The dot layout illustrated in FIG. 6B includes black dots 1501 recorded only in the first scanning and recording operation, white dots 1502 recorded only in the second scanning and recording operation, and gray dots 1503 recorded duplicatedly in both the first scanning and recording operation and the second scanning and recording operation.

According to the example illustrated in FIG. 6B, there is not a complementary relationship between the dots recorded in the first scanning and recording operation and the dots recorded in the second scanning and recording operation. Accordingly, compared to the case illustrated in FIG. 6A in which the complementary relationship is perfect, some gray dots 1503 are generated at portions where two dots are overlapped and some blank areas are present at portions where no dot is recorded.

In the following description, an assembly of a plurality of dots recorded in the first scanning and recording operation is referred to as a first plane. An assembly of a plurality of dots recorded in the second scanning and recording operation is referred to as a second plane. It is now assumed that the first plane and the second plane are mutually deviated in a main scanning direction or in a sub scanning direction by an amount equivalent to one pixel. In this case, if the first plane and the second plane are in the completely complementary relationship (see FIG. 6A), the dots to be recorded as the first plane completely overlap with the dots to be recorded as the second plane. As a result, blank areas are exposed and the image density greatly decreases.

The dot covering rate (and the image density) in the blank area is greatly influenced by a variation in the distance (or in the overlap portion) between neighboring dots, even if the variation is smaller than one pixel. More specifically, if the above-described deviation between the planes changes according to a variation in the distance between a recording medium and a discharge port surface (i.e., the head-to-sheet distance), or according to a variation in the conveyance amount of the recording medium, a uniform image density changes correspondingly and may be recognized as an uneven density.

On the other hand, in the case illustrated in FIG. 6B, even if a deviation occurring between the first plane and the second plane is comparable to one pixel, the dot covering rate on a recording medium does not change so much. On the one hand, there is a portion where the dots recorded in the first scanning and recording operation may be newly overlapped with the dots recorded in the second scanning and recording operation, but on the other hand, there is a portion where two dots already recorded in an overlapped fashion may separate. Accordingly, the dot covering rate in a wider area (or in the whole area) of recording medium does not change so much and the image density does not substantially change.

More specifically, if the method discussed in U.S. Pat. No. 6,551,143 or Japanese Patent Application Laid-Open No. 2001-150700 is employed, even when a variation occurs in the distance between a recording medium and a discharge port surface (i.e., the head-to-sheet distance) or in the conveyance amount of the recording medium, it becomes feasible to prevent an image from containing a defective part, such as a density variation or an uneven density. Thus, it becomes feasible to output an image excellent in robustness.

However, according to the above-described method, when a recording element group that discharges the same ink is used to perform an M (M being an integer equal to or greater than 3)-pass recording operation, input image data is separated into multi-valued image data corresponding to M planes and quantization processing is performed on the multi-valued image data corresponding to M planes. Accordingly, the number of target data to be subjected to the quantization processing increases excessively. The data processing load becomes larger. As described above, the conventional method cannot reduce the data processing load while suppressing the above-described density variation.

### SUMMARY OF THE INVENTION

The present invention is directed to an image processing apparatus, an image processing method, and a recording apparatus, which can suppress a density variation that may occur due to a deviation in dot recording position while reducing data processing load.

According to an aspect of the present invention, an image processing apparatus can process input image data corresponding to an image to be recorded in a predetermined area of a recording medium through M relative movements between a recording element group configured to discharge a same color ink and the recording medium. The image processing apparatus according to the present invention includes a first generation unit configured to generate N pieces of same color multi-valued image data from the input image data, a second generation unit configured to generate the N pieces of quantized data by performing quantization processing on the N pieces of same color multi-valued image data generated by the first generation unit, and a third generation unit configured to divide at least one piece of quantized data, among the N pieces of quantized data generated by the second generation unit, into a plurality of quantized data and generate M pieces of quantized data corresponding to the M relative movements. Further, the M pieces of quantized data includes quantized data corresponding to an edge portion of the recording element group and quantized data corresponding to a central portion of the recording element group, and a recording duty of the quantized data corresponding to the edge portion is set to be lower than a recording duty of the quantized data corresponding to the central portion.

The present invention can suppress a density variation that may occur due to a deviation in dot recording position, while reducing the data processing load.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a perspective view illustrating a photo direct printing apparatus (hereinafter, referred to as “PD printer”) according to an exemplary embodiment of the present invention.

FIG. 2 is a schematic view illustrating an operation panel of the PD printer according to an exemplary embodiment of the present invention.

FIG. 3 is a block diagram illustrating a configuration of main part of a control system for the PD printer according to an exemplary embodiment of the present invention.

FIG. 4 is a block diagram illustrating an internal configuration of a printer engine according to an exemplary embodiment of the present invention.

FIG. 5 is a perspective view illustrating a schematic configuration of a recording unit of a printer engine of a serial type inkjet recording apparatus according to an exemplary embodiment of the present invention.

FIG. 6A illustrates an example dot layout in a case where mask patterns having a mutually complementary relationship are used to divide image data, and FIG. 6B illustrates another example dot layout in a case where image data is divided according to the method discussed in U.S. Pat. No. 6,551,143 or Japanese Patent Application Laid-Open No. 2001-150700.

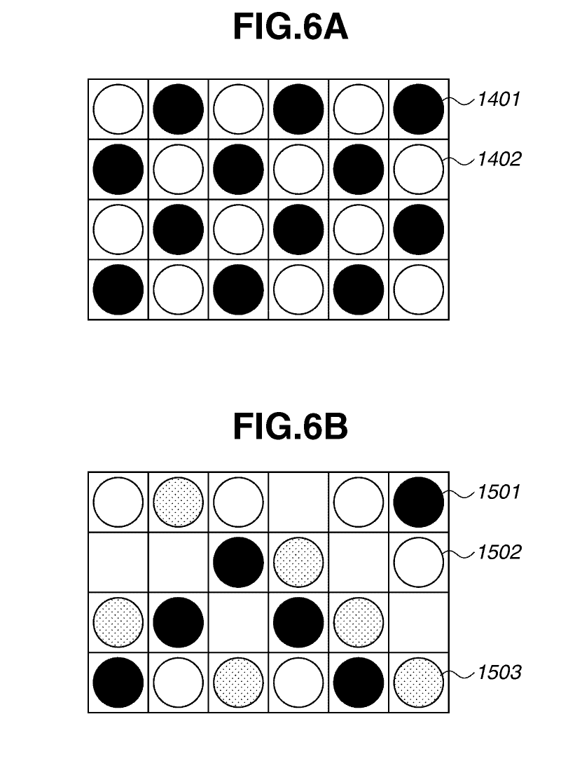

FIGS. 7A to 7H illustrate examples of dot overlapping rates.

FIG. 8 illustrates an example of mask patterns that can be employed in the present invention.

FIG. 9A illustrates an example of decentralized dots, and FIG. 9B illustrates an example of dots where overlapped dots and adjacent dots are irregularly disposed.

FIG. 10 is a block diagram illustrating a conventional image data distribution system.

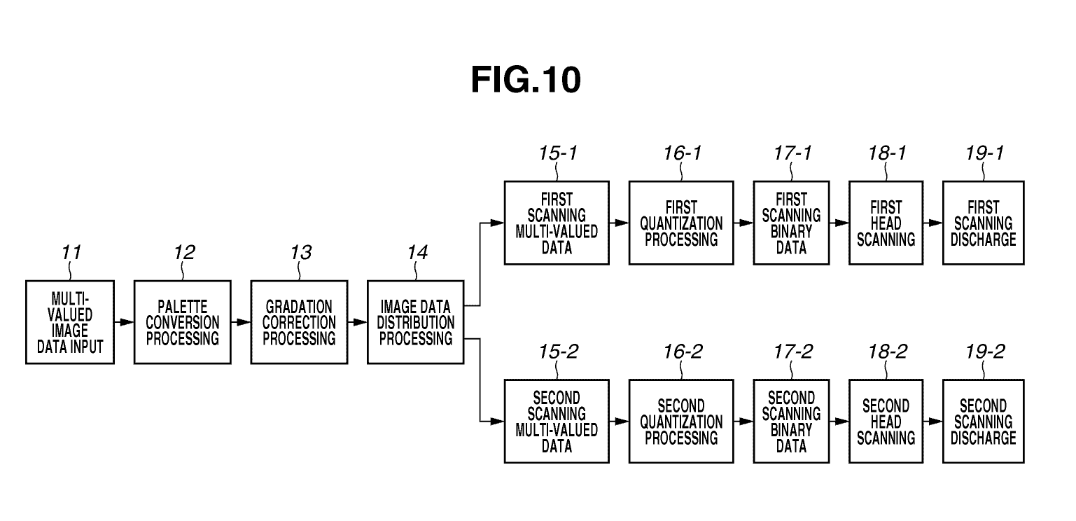

FIG. 11 illustrates an example of a 2-pass (multi-pass) recording operation.

FIG. 12 schematically illustrates a practical example of image processing illustrated in FIG. 21.

FIGS. 13A and 13B illustrate error diffusion matrices that can be used in quantization processing.

FIGS. 14A to 14D illustrate an example processing flow including generation of quantized data corresponding to a plurality of scanning operations, allocation of the generated quantized data to each scanning operation, and recording performed based on the allocated quantized data.

FIG. 15 illustrates a conventional quantized data management method that corresponds to a plurality of scanning operations.

FIG. 16 illustrates an example management of quantized data generated on two planes according to the conventional data management method illustrated in FIG. 15.

FIG. 17 illustrates an example quantized data management method that corresponds to a plurality of scanning operations according to a modified embodiment of a third exemplary embodiment of the present invention.

FIG. 18 is a block diagram illustrating example image processing according to a modified embodiment of a fourth exemplary embodiment of the present invention, in which a multi-pass recording operation is performed to form an image in the same area through five scanning and recording operations.

FIG. 19 is a flowchart illustrating an example of quantization processing that can be executed by a control unit according to a modified embodiment of a second exemplary embodiment of the present invention.

FIG. 20 is a schematic view illustrating a surface of a recording head on which discharge ports are formed.

FIG. 21 is a block diagram illustrating example image processing, in which the multi-pass recording operation is performed to form an image in the same area through two scanning and recording operations.

FIGS. 22A to 22G illustrate various examples of binary quantization processing results (K1″, K2″) obtained using threshold data described in threshold table 1 in relation to input values (K1ttl, K2ttl).

FIG. 23 is a flowchart illustrating an example of quantization processing that can be executed by the control unit according to the second exemplary embodiment of the present invention.

### DESCRIPTION OF THE EMBODIMENTS

Various exemplary embodiments, features, and aspects of the invention will be described in detail below with reference to the drawings.

The following exemplary embodiments are described based on an inkjet recording apparatus. However, the present invention is not limited to only the inkjet recording apparatus. The present invention can be applied to any type of recording apparatus other than the inkjet recording apparatus if the apparatus can record an image on a recording medium with a recording unit configured to record dots while causing a relative movement between the recording unit and the recording medium.

In the context of the following exemplary embodiments, the “relative movement (or relative scanning)” between the recording unit and a recording medium indicates a movement of the recording unit that performs scanning relative to the recording medium, or indicates a movement of the recording medium that is conveyed relative to the recording unit.

In a case where a serial type recording apparatus executes a multi-pass recording operation, the recording head performs a plurality of scanning operations in such a manner that the recording unit can repetitively face the same area of the recording medium.

On the other hand, in a case where a full-line type recording apparatus executes a multi-pass recording operation, the conveyance operation of the recording medium is performed a plurality of times in such a manner that the recording unit can repetitively face the same area of the recording medium. Further, the recording unit indicates at least one recording element group (or nozzle array) or at least one recording head.

An image processing apparatus described in the following exemplary embodiments performs data processing for recording an image in the above-described same area of the recording medium through a plurality of relative movements caused by the recording unit relative to the same area (i.e., a predetermined area). In the context of the following exemplary embodiments, the “same area (predetermined area)” indicates a “one pixel area” in a narrow sense or indicates a “recordable area during a single relative movement” in a broad sense.

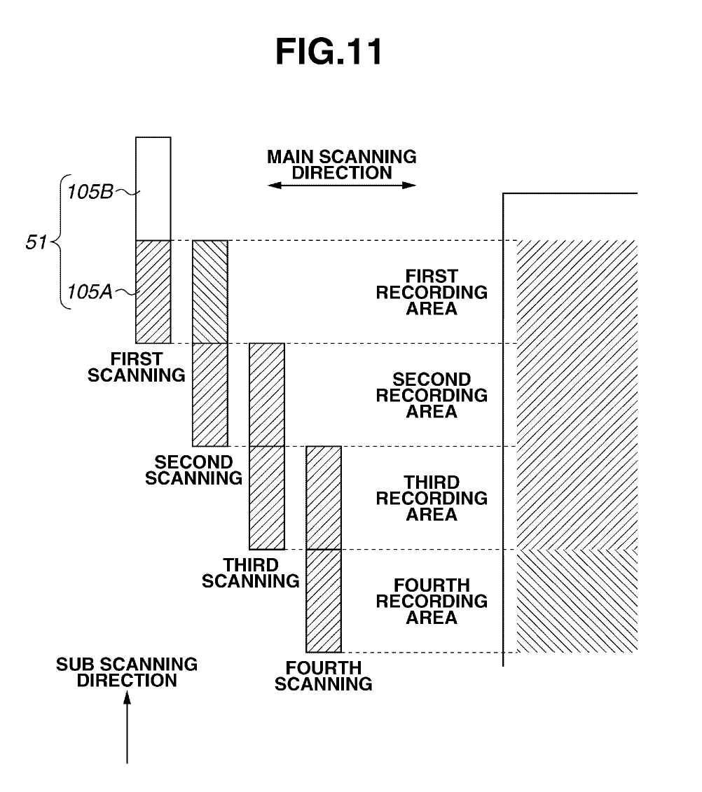

Further, the “pixel area (that may be simply referred to as “pixel”)” indicates a minimum unit area whose gradational expression is feasible using multi-valued image data. On the other hand, the “recordable area during a single relative movement” indicates an area of the recording medium where the recording unit can travel during a single relative movement, or an area (e.g., one raster area) smaller than the above-described area. For example, in a case where the serial type recording apparatus performs an M (M being an integer equal to or greater than 2)-pass recording operation as illustrated in FIG. 11, each recording area illustrated in FIG. 11 can be defined as “same area” in a broad sense.

### <Schematic Configuration of Recording Apparatus>

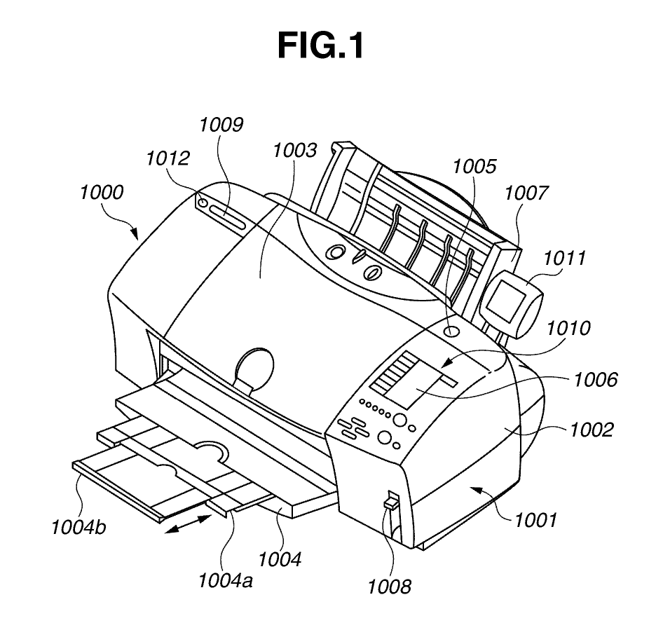

FIG. 1 is a perspective view illustrating a photo direct printing apparatus (hereinafter, referred to as “PD printer”) 1000, more specifically, an image forming apparatus (an image processing apparatus) according to an exemplary embodiment of the present invention. The PD printer 1000 is functionally operable as an ordinary PC printer that prints data received from a host computer (PC) and has the following various functions. More specifically, the PD printer 1000 can directly print image data read from a storage medium (e.g., a memory card). The PD printer 1000 can read image data received from a digital camera or a Personal Digital Assistant (PDA), and print the image data.

In FIG. 1, a main body (an outer casing) of the PD printer 1000 according to the present exemplary embodiment includes a lower casing 1001, an upper casing 1002, an access cover 1003, and a discharge tray 1004. The lower casing 1001 forms a lower half of the PD printer 1000 and the upper casing 1002 forms an upper half of the main body. In a state where the upper and lower casings 1001 and 1002 are combined with each other, a hollow housing structure can be formed to accommodate the following mechanisms. An opening portion is formed on each of an upper surface and a front surface of the printer housing.

The discharge tray 1004 can freely swing about its edge portion supported at one edge of the lower casing 1001. The lower casing 1001 has an opening portion formed on the front surface side thereof, which can be opened or closed by rotating the discharge tray 1004. More specifically, when a recording operation is performed, the discharge tray 1004 is rotated forward and held at its open position. Each recorded recording medium (e.g., a plain paper, a special paper, or a resin sheet) can be discharged via the opening portion and can be sequentially stacked on the discharge tray 1004.

Further, the discharge tray 1004 includes two auxiliary trays 1004a and 1004b that are retractable in an inner space of the discharge tray 1004. Each of the auxiliary trays 1004a and 1004b can be pulled out to expand a support area for a recording medium in three stages.

The access cover 1003 can freely swing about its edge portion supported at one edge of the upper casing 1002, so that an opening portion formed on the upper surface can be opened or closed. In a state where the access cover 1003 is opened, a recording head cartridge (not illustrated) or an ink tank (not illustrated) can be installed in or removed from the main body.

When the access cover 1003 is opened or closed, a protrusion formed on its back surface causes a cover open/close lever to rotate and its rotational position can be detected by a micro-switch. The micro-switch generates a signal indicating an open/close state of the access cover 1003.

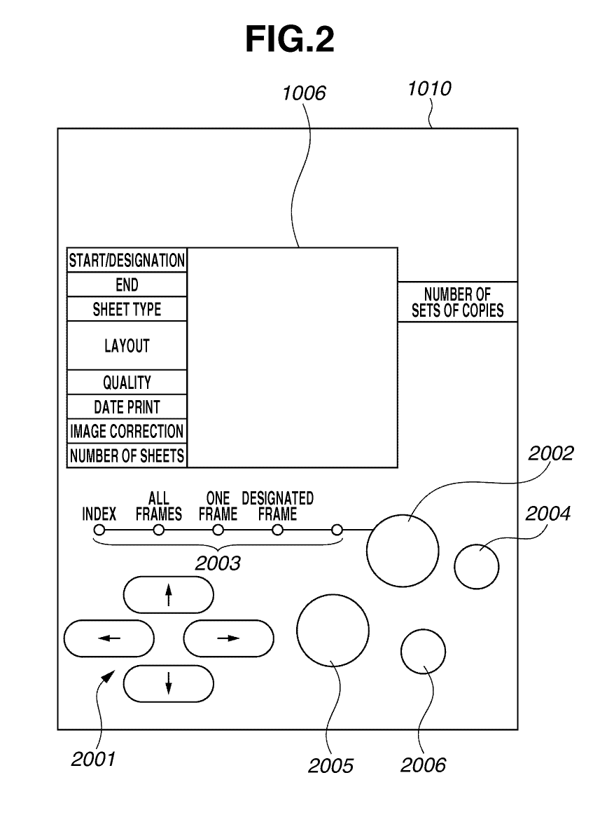

A power source key 1005 is provided on the upper surface of the upper casing 1002. An operation panel 1010 is provided on the right side of the upper casing 1002. The operation panel 1010 includes a liquid crystal display device 1006 and various key switches. Referring to FIG. 2, details of an example structure of the operation panel 1010 will be described below. An automatic feeder 1007 can automatically feed a recording medium to an internal space of the apparatus main body. A head-to-sheet selection lever 1008 can adjust a clearance between the recording head and the recording medium.

The PD printer 1000 can directly read image data from a memory card when the memory card attached to an adapter is inserted into a card slot 1009. The memory card (PC) is, for example, a Compact Flash® memory, a smart medium, or a memory stick.

A viewer (e.g., a liquid crystal display device) 1011 is detachably attached to the main body of the PD printer 1000. When a user searches for an image to be printed from a PC card that stores a plurality of images, the image of each frame or index images can be displayed on the viewer 1011. As described below, the PD printer 1000 can be connected to a digital camera via a Universal Serial Bus (USB) terminal 1012. The PD apparatus 1000 includes a USB connector on its back surface, via which the PD printer 1000 can be connected to a personal computer (PC).

### <Schematic Configuration of Operation Unit>

FIG. 2 is a schematic view illustrating the operation panel 1010 of the PD printer 1000 according to an exemplary embodiment of the present invention. In FIG. 2, the liquid crystal display device 1006 can display a menu item to enable users to perform various setting for print conditions. For example, the print conditions include the following items:

photo number of head photo image to be printed among a plurality of photo image files frame number designation (start frame designation/print frame designation)

photo number of the final photo image to be printed (end)

number of sets to be printed (number of sets of copies)

type of recording medium to be used in printing (sheet type)

setting with respect to total number of photos to be printed on a recording medium (layout)

designation of print quality (quality)

designation whether to print the date of photographing (date print)

designation whether to perform correction on a photo image before printing (image correction)

display of the number of recording media required in printing (number of sheets)

Four (i.e., upper, lower, right, and left) cursor keys 2001 are operable to select or designate the above-described items. Further, each time when a mode key 2002 is pressed, the type of printing can be switched, for example, between index printing, all-frame printing, one-frame printing, designated frame printing), and a light-emitting diode (LED) 2003 is turned on correspondingly.

A maintenance key 2004 can be pressed when the recording head is required to be cleaned or for maintenance of the recording apparatus. Users can press a print start key 2005 to instruct a printing operation or to confirm settings for the maintenance. Further, users can press a printing stop key 2006 to stop the printing operation or to cancel a maintenance operation.

### <Schematic Electrical Arrangement of Control Unit>

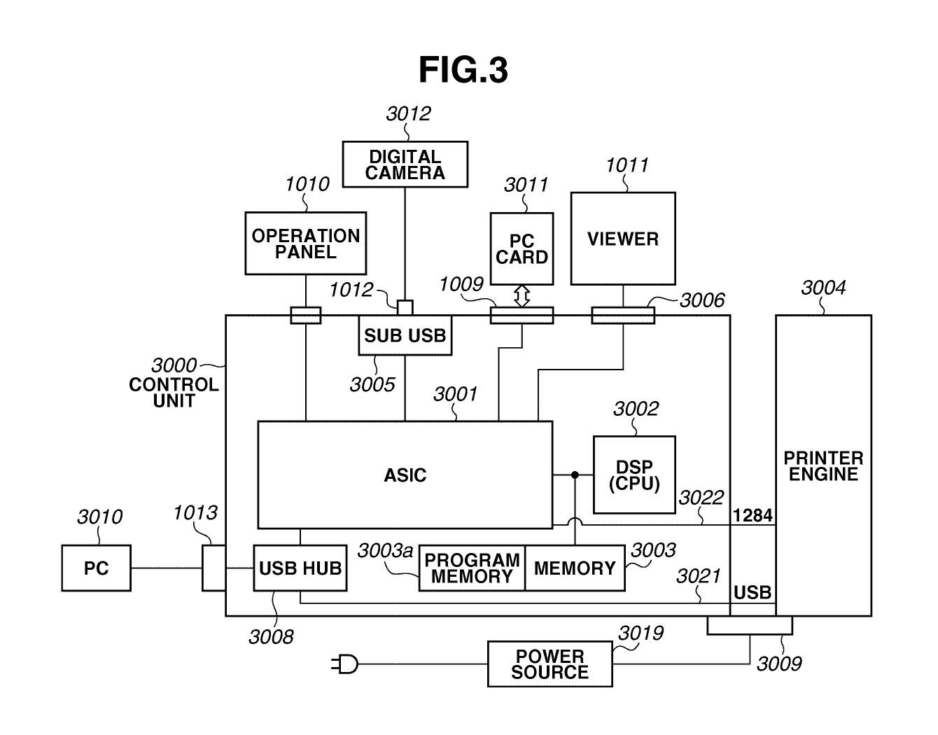

FIG. 3 is a block diagram illustrating a configuration of main part of a control system for the PD printer 1000 according to an exemplary embodiment of the present invention. In FIG. 3, portions similar to the above-described portions are denoted by the same reference numerals and the descriptions thereof are not repeated. As apparent from the following description, the PD printer 1000 is functionally operable as an image processing apparatus.

The control system illustrated in FIG. 3 includes a control unit (a control substrate) 3000, which includes an image processing ASIC (i.e., a dedicated custom LSI) 3001 and a digital signal processing unit (DSP) 3002. The DSP 3002 includes a built-in central processing unit (CPU), which can perform control processing as described below and can perform various image processing, such as luminance signal (RGB) to density signal (CMYK) conversion, scaling, gamma conversion, and error diffusion.

In the control unit 3000, a memory 3003 includes a program memory 3003a that stores a control program for the CPU of the DSP 3002, a random access memory (RAM) area that stores a currently executed program, and a memory area functionally operable as a work memory that can store image data.

The control system illustrated in FIG. 3 further includes a printer engine 3004 for an inkjet printer that can print a color image with a plurality of color inks. A digital still camera (DSC) 3012 is connected to a USB connector 3005 (i.e., a connection port).

The viewer 1011 is connected to a connector 3006. When the PD printer 1000 performs printing based on image data supplied from a personal computer (PC) 3010, a USB hub 3008 can directly output the data from the PC 3010 to the printer engine 3004 via a USB terminal 3021. Thus, the PC 3010 connected to the control unit 3000 can directly transmit and receive printing data and signals to and from the printer engine 3004. In other words, the PD printer 1000 is functionally operable as a general PC printer.

A power source 3019 can supply a DC voltage converted from a commercial AC voltage, to a power source connector 3009. The PC 3010 is a general personal computer. A memory card (i.e., a PC card) 3011 is connected to the card slot 1009.

The control unit 3000 and the printer engine 3004 can perform the above-described transmission/reception of data and signals via the above-described USB terminal 3021 or an IEEE1284 bus 3022.

### <Electrical Arrangement of Printer Engine>

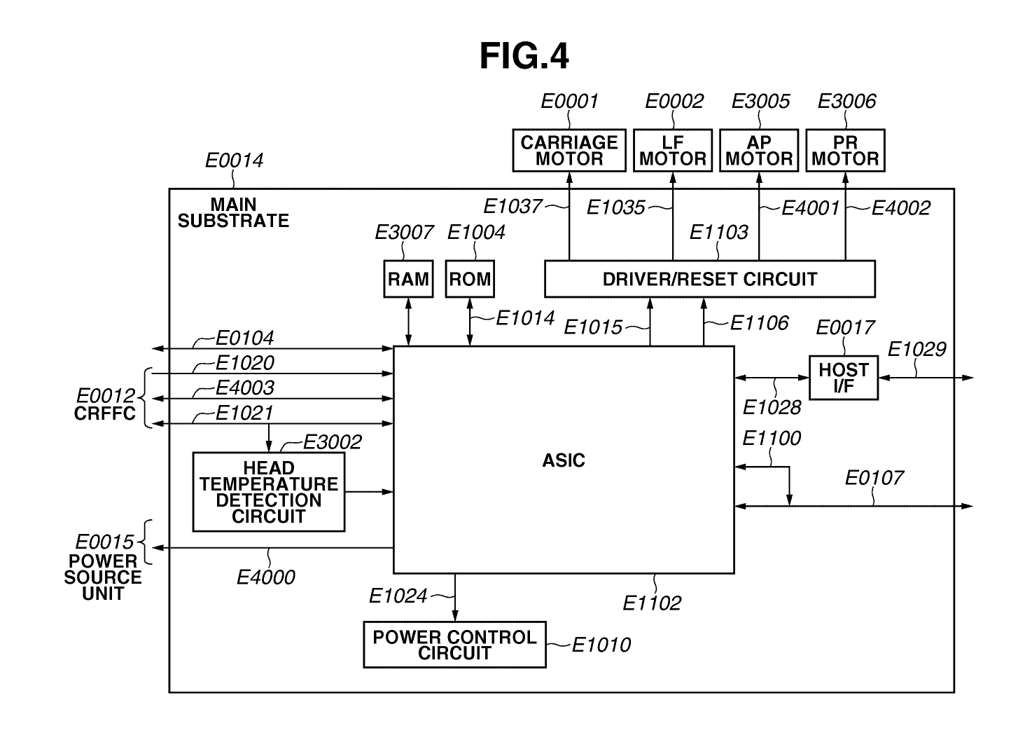

FIG. 4 is a block diagram illustrating an internal configuration of the printer engine 3004 according to an exemplary embodiment of the present invention. The printer engine 3004 illustrated in FIG. 4 includes a main substrate E0014 on which an engine unit Application Specific Integrated Circuit (ASIC) E1102 is provided. The engine unit ASIC E1102 is connected to a ROM E1004 via a control bus E1014. The engine unit ASIC E1102 can perform various controls according to programs stored in the ROM E1004. For example, the engine unit ASIC E1102 transmits/receives a sensor signal E0104 relating to various sensors and a multi-sensor signal E4003 relating to a multi-sensor E3000.

Further, the engine unit ASIC E1102 receives an encoder signal E1020 and detects output states of the power source key 1005 and various keys on the operation panel 1010. Further, the engine unit ASIC E1102 performs various logical calculations and conditional determinations based on connection and data input states of a host I/F E0017 and a device I/F E0100 on a front panel. Thus, the engine unit ASIC E1102 controls each constituent component and performs driving control for the PD printer 1000.

The printer engine 3004 illustrated in FIG. 4 further includes a driver/reset circuit E1103 that can generate a CR motor driving signal E1037, an LF motor driving signal E1035, an AP motor driving signal E4001, and a PR motor driving signal E4002 according to a motor control signal E1106 from the engine unit ASIC E1102. Each of the generated driving signals is supplied to a corresponding motor.

Further, the driver/reset circuit E1103 includes a power source circuit, which supplies electric power required for each of the main substrate E0014, a carriage substrate provided on a moving carriage that mounts the recording head, and the operation panel 1010. When a reduction in power source voltage is detected, the driver/reset circuit E1103 generates and initializes a reset signal E1015.

The printer engine 3004 illustrated in FIG. 4 further includes a power control circuit E1010 that can control power supply to each sensor having a light emitting element according to a power control signal E1024 supplied from the engine unit ASIC E1102.

The host I/F E0017 is connected to the PC 3010 via the image processing ASIC 3001 and the USB hub 3008 provided in the control unit 3000 illustrated in FIG. 3. The host I/F E0017 can transmit a host I/F signal E1028, when supplied from the engine unit ASIC E1102, to a host I/F cable E1029. Further, the host I/F E0017 can transmit a signal, if received from the host I/F cable E1029, to the engine unit ASIC E1102.

The printer engine 3004 can receive electric power from a power source unit E0015 connected to the power source connector 3009 illustrated in FIG. 3. The electric power supplied to the printer engine 3004 is converted, if necessary, into an appropriate voltage and supplied to each internal/external element of the main substrate E0014. On the other hand, the engine unit ASIC E1102 transmits a power source unit control signal E4000 to the power source unit E0015. The power source unit control signal E4000 can be used to control an electric power mode (e.g., a low power consumption mode) for the PD printer 1000.

The engine unit ASIC E1102 is a semiconductor integrated circuit including a single-chip calculation processor. The engine unit ASIC E1102 can output the above-described motor control signal E1106, the power control signal E1024, and the power source unit control signal E4000. Further, the engine unit ASIC E1102 can transmit/receive a signal to/from the host I/F E0017. The engine unit ASIC E1102 can further transmit/receive a panel signal E0107 to/from the device I/F E0100 on the operation panel.

Further, the engine unit ASIC E1102 detects an operational state based on the sensor signal E0104 received from a PE sensor, an ASF sensor, or another sensor. Further, the engine unit ASIC E1102 controls the multi-sensor E3000 based on the multi-sensor signal E4003 and detects its operational state. Further, the engine unit ASIC E1102 performs driving control for the panel signal E0107 based on a detected state of the panel signal E0107 and performs ON/OFF control for the LED 2003 provided on the operation panel.

Further, the engine unit ASIC E1102 can generate a timing signal based on a detected state of the encoder signal (ENC) E1020 to control a recording operation while interfacing with a head control signal E1021 of a recording head 5004. In the present exemplary embodiment, the encoder signal (ENC) E1020 is an output signal of an encoder sensor E0004, which can be input via a CRFFC E0012.

Further, the head control signal E1021 can be transmitted to the carriage substrate (not illustrated) via the flexible flat cable E0012. The head control signal received by the carriage substrate can be supplied to a recording head H1000 via a head driving voltage modulation circuit and a head connector. Further, various kinds of information obtained from the recording head H1000 can be transmitted to the engine unit ASIC E1102. For example, head temperature information obtained from each discharging unit is amplified, as a temperature signal, by a head temperature detection circuit E3002 on the main substrate. Then, the temperature signal is supplied to the engine unit ASIC E1102 and can be used in various control determinations.

The printer engine 3004 illustrated in FIG. 4 further includes a DRAM E3007, which can be used as a recording data buffer or can be used as a reception data buffer F115 connected to the PC 3010 via the image processing ASIC 3001 or the USB hub 3008 provided in the control unit 3000 illustrated in FIG. 3. Further, a print buffer F118 is prepared to store recording data to be used to drive the recording head. The DRAM E3007 is also usable as a work area required for various control operations.

### <Arrangement of Recording Unit>

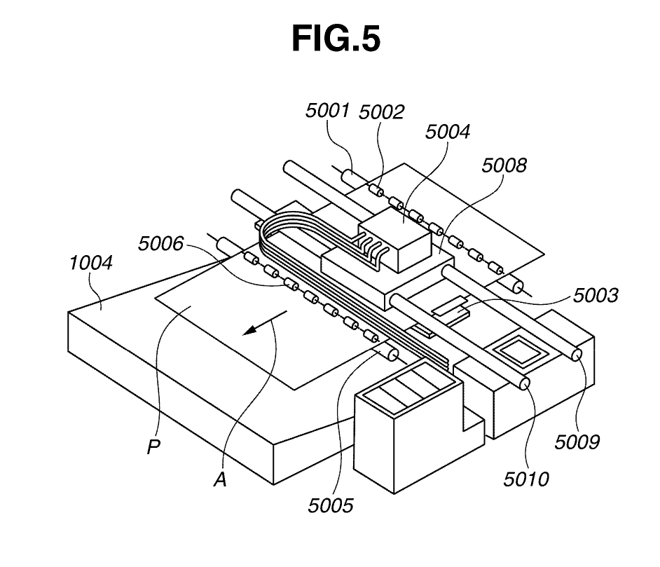

FIG. 5 is a perspective view illustrating a schematic configuration of a recording unit of a printer engine of a serial type inkjet recording apparatus according to an exemplary embodiment of the present invention. The automatic feeder 1007 (see FIG. 1) feeds a recording medium P to a nip portion between a conveyance roller 5001, which is located on a conveyance path, and a pinch roller 5002, which is driven by the conveyance roller 5001. Subsequently, the conveyance roller 5001 rotates around its rotational axis to guide the recording medium P to a platen 5003. The recording medium P, while it is supported by the platen 5003, moves in the direction indicated by an arrow A (i.e., the sub scanning direction).

A pressing unit, such as a spring (not illustrated) elastically urges the pinch roller 5002 against the conveyance roller 5001. The conveyance roller 5001 and the pinch roller 5002 are constituent components cooperatively constituting a first conveyance unit, which is positioned on the upstream side in the conveyance direction of the recording medium P.

The platen 5003 is positioned at a recording position that faces a discharge surface of the inkjet recording head 5004 on which discharge ports are formed. The platen 5003 supports a back surface of the recording medium P in such a way as to maintain a constant distance between the surface of the recording medium P and the discharge surface.

After a recording operation on the recording medium P having been conveyed to the platen 5003 is completed, the recording medium P is inserted between a rotating discharge roller 5005 and a spur 5006 (i.e., a rotary member driven by the rotating discharge roller 5005). Then, the recording medium P is conveyed in the direction A until the recording medium P is discharged from the platen 5003 to the discharge tray 1004. The discharge roller 5005 and the spur 5006 are constituent components cooperatively constitute a second conveyance unit, which is positioned on the downstream side in the conveyance direction of the recording medium P.

The recording head 5004 is detachably mounted on a carriage 5008 in such a way as to hold the discharge port surface of the recording head 5004 in an opposed relationship with the platen 5003 or the recording medium P. The carriage 5008 can travel, when the driving force of a carriage motor E0001 is transmitted, in the forward and reverse directions along two guide rails 5009 and 5010. The recording head 5004 performs an ink discharge operation according to a recording signal in synchronization with the movement of the carriage 5008.

The direction along which the carriage 5008 travels is a direction perpendicular to the conveyance direction of the recording medium P (i.e., the direction indicated by the arrow A). The traveling direction of the carriage 5008 is referred to as the “main scanning direction.” On the other hand, the conveyance direction of the recording medium P is referred to as the “sub scanning direction.” The recording operation on the recording medium P can be accomplished by alternately repeating the recording operation of the carriage 5008 and the recording head 5004 in the main scanning direction and the conveyance operation of the recording medium in the sub scanning direction.

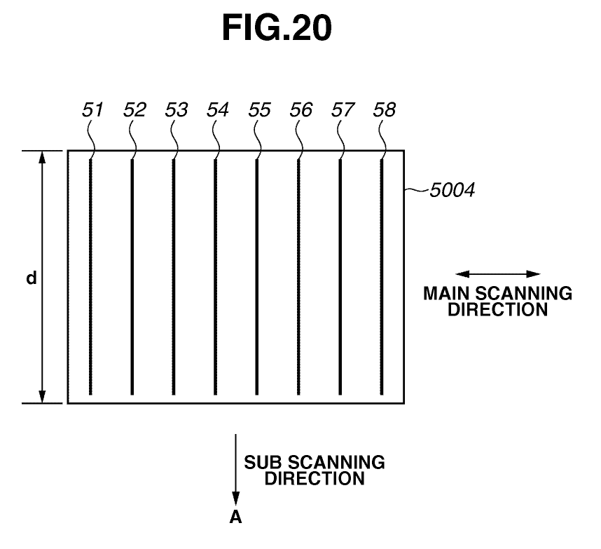

FIG. 20 is a schematic view illustrating the discharge surface of the inkjet recording head 5004 on which discharge ports are formed. The inkjet recording head 5004 illustrated in FIG. 20 includes a plurality of recording element groups. More specifically, the inkjet recording head 5004 includes a first cyan nozzle array 51, a first magenta nozzle array 52, a first yellow nozzle array 53, a first black nozzle array 54, a second black nozzle array 55, a second yellow nozzle array 56, a second magenta nozzle array 57, and a second cyan nozzle array 58. Each nozzle array has a width “d” in the sub scanning direction. Therefore, the inkjet recording head 5004 can realize a recording of width “d” during one scanning operation.

The recording head 5004 according to the present exemplary embodiment includes two nozzle arrays, each having the capability of discharging the same amount of ink, for each color of cyan (C), magenta (M), yellow (Y), and black (K). The recording head 5004 can record an image on a recording medium with each of these nozzle arrays. In other words, the recording head 5004 according to the present exemplary embodiment can reduce the uneven density or streaks that may occur due to differences of individual nozzles to an approximately half level.

Further, symmetrically disposing a plurality of nozzle arrays of respective colors in the main scanning direction as described in the present exemplary embodiment is useful in that the ink discharging operation of a plurality of colors relative to a recording medium can be performed according to the same order when a scanning and recording operation is performed in the forward direction and when a scanning and recording operation is performed in the backward direction.

More specifically, the ink discharging order relative to a recording medium is C→M→Y→K→K→Y→M→C in both the forward direction and the backward direction. Therefore, even when the recording head 5004 performs a bidirectional recording operation, irregular color does not occur due to the difference in ink discharging order.

Further, the recording apparatus according to the present exemplary embodiment can perform a multi-pass recording operation. Therefore, a stepwise image formation can be realized by performing a plurality of scanning and recording operations in an area where the recording head 5004 can perform recording in a single scanning and recording operation. In this case, if a conveyance operation between respective scanning and recording operations is performed by an amount smaller than the width d of the recording head 5004, the uneven density or streaks that may occur due to differences of individual nozzles can be reduced effectively.

The determination whether to perform the multi-pass recording operation or the multi-pass number (the number of times the scanning and recording operation is performed in the similar area) can be adequately determined according to information input by a user via the operation panel 1010 or image information received from a host apparatus.

Next, an example multi-pass recording operation that can be performed by the above-described recording apparatus is described below with reference to FIG. 11. The example multi-pass recording operation illustrated in FIG. 11 is 2-pass recording operation. However, the present invention is not limited to the 2-pass recording, and can be applied to any other M-pass (M being an integer equal to or greater than 3) recording, such as 3-pass, 4-pass, 8-pass, or 16-pass recording.

The “M-pass mode”, (M being an integer equal to or greater than 3), according to the present invention is a mode in which the recording head 5004 performs recording in the similar area of a recording medium based on M scanning operations of the recording element groups while conveying the recording medium by an amount smaller than the width of a recording element layout range.

In the above-described M-pass mode, it is desired to set each conveyance amount of a recording medium to be equal to an amount corresponding to 1/M of the width of the recording element layout range. If the above-described setting is performed, the width of the above-described similar area in the conveyance direction becomes equal to a width corresponding to each conveyance amount of the recording medium.

FIG. 11 schematically illustrates a relative positional relationship between the recording head 5004 and a plurality of recording areas in an example 2-pass recording operation, in which the recording head 5004 performs recording in four (first to fourth) recording areas that correspond to four similar areas. The illustration in FIG. 11 includes only one nozzle array (i.e., one recording element group) 61 of a specific color of the recording head 5004 illustrated in FIG. 5.

In the following description, among a plurality of nozzles (recording elements) that constitute the nozzle array (i.e., the recording element group) 61, a nozzle group positioned on the upstream side in the conveyance direction is referred to as an upstream side nozzle group 61A. A nozzle group positioned on the downstream side in the conveyance direction is referred to as a downstream side nozzle group 61B. Further, the width of each similar area (each recording area) in the sub scanning direction (i.e., in the conveyance direction) is equal to a width corresponding to approximately one half (corresponding to 640 nozzles) of the width of the layout range of a plurality of recording elements (corresponding to 1280 nozzles) provided on the recording head.

In the first scanning operation, the recording head 5004 activates only the upstream side nozzle group 61A to record a part (a half) of an image to be recorded in the first recording area. The image data to be recorded by the upstream side nozzle group 61A for individual pixels has a gradation value comparable to approximately one half of that of the original image data (i.e., multi-valued image data corresponding to an image to be finally recorded in the first recording area). After the above-described first scanning and recording operation is completed, the recording apparatus conveys a recording medium along the Y direction by a moving amount comparable to 640 nozzles.

Next, in the second scanning operation, the recording head 5004 activates the upstream side nozzle group 61A to record a part (a half) of an image to be recorded in the second recording area and also activates the downstream side nozzle group 61B to complete the image to be recorded in the first recording area. The image data to be recorded by the downstream side nozzle group 61B has a gradation value comparable to approximately one half of that of the original image data (i.e., multi-valued image data corresponding to the image to be finally recorded in the first recording area).

Through the above-described operations, recording of image data whose gradation value is approximately one half of the original value is performed two times in the first recording area. Therefore, the gradation value of the original image data can be substantially stored in the first recording area. After the above-described second scanning and recording operation is completed, the recording apparatus conveys the recording medium along the Y direction by a moving amount comparable to 640 nozzles.

Next, in the third scanning operation, the recording head 5004 activates the upstream side nozzle group 61A to record a part (a half) of an image to be recorded in the third recording area and also activates the downstream side nozzle group 61B to complete the image to be recorded in the second recording area. Subsequently, the recording apparatus conveys the recording medium along the Y direction by a moving amount comparable to 640 nozzles.

Finally, in the fourth scanning operation, the recording head 5004 activates the upstream side nozzle group 61A to record a part (a half) of an image to be recorded in the fourth recording area and also activates the downstream side nozzle group 61B to complete the image to be recorded in the third recording area. Subsequently, the recording apparatus conveys the recording medium along the Y direction by a moving amount comparable to 640 nozzles.

The recording head 5004 performs similar recording operations for other recording areas. In this manner, the recording apparatus according to the present exemplary embodiment performs the 2-pass recording operation in each recording area by repeating the above-described scanning and recording operation in the main scanning direction and the sheet conveyance operation in the sub scanning direction.

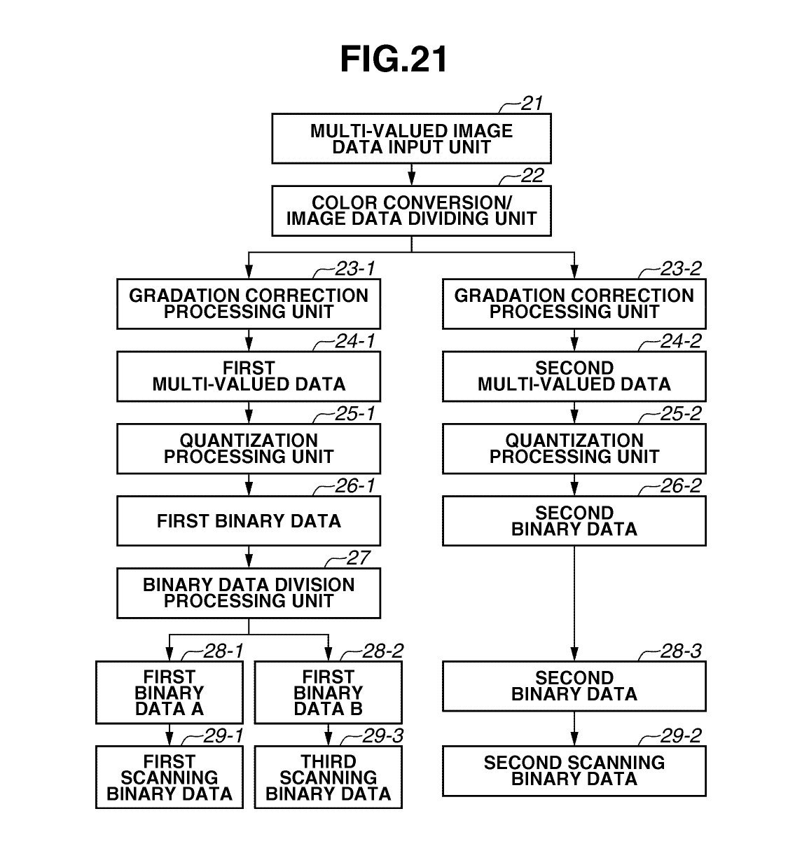

FIG. 21 is a block diagram illustrating example image processing that can be performed by the control system in a case where the multi-pass recording operation is performed to form a composite image in the same area of a recording medium through three scanning and recording operations. In the present exemplary embodiment, the control unit 3000 illustrated in FIG. 3 performs sequential processing indicated by reference numerals 21 to 25 illustrated in FIG. 21 on image data having been input from an image input device such as the digital camera 3012. The printer engine 3004 performs subsequent processing indicated by reference numerals 27 to 29.

In FIG. 21, a multi-valued image data input unit (21), a color conversion/image data dividing unit (22), a gradation correction processing unit (23-1, 23-2) and a quantization processing unit (25-1, 25-2) are functional units included in the control unit 3000. On the other hand, a binary data division processing unit (27-1, 27-2) is included in the printer engine 3004.

The multi-valued image data input unit 21 inputs RGB multi-valued image data (256 values) from an external device. The color conversion/image data dividing unit 22 converts the input image data (multi-valued RGB data), for each pixel, into two sets of multi-valued image data (CMYK data) of first recording density multi-valued data and second recording density multi-valued data corresponding to each ink color.

More specifically, a three-dimensional look-up table that stores CMYK values (C1, M1, Y1, K1) of first multi-valued data and CMYK values (C2, M2, Y2, K2) of second multi-valued data in relation to RGB values is provided beforehand in the color conversion/image data dividing unit 22. The color conversion/image data dividing unit 22 can convert the multi-valued RGB data, in block, into the first multi-valued data (C1, M1, Y1, K1) and the second multi-valued data (C2, M2, Y2, K2) with reference to the three-dimensional look-up table (LUT).

In this case, if an input value does not coincide with any grid point values in the table, it is useful to calculate an interpolated value with reference to output values corresponding to peripheral grid points in the table. As described above, the color conversion/image data dividing unit 22 has a role of generating the first multi-valued data (C1, M1, Y1, K1) and the second multi-valued data (C2, M2, Y2, K2), for each pixel, from the input image data. In this respect, the color conversion/image data dividing unit 22 can be referred to as “first generation unit.”

The configuration of the color conversion/image data dividing unit 22 is not limited to the employment of the above-described three-dimensional look-up table. For example, it is useful to convert the multi-valued RGB data into multi-valued CMYK data corresponding to the inks used in the recording apparatus and then divide each of the multi-valued CMYK data into two pieces of data.

Next, the first multi-valued data and the second multi-valued data are subjected, for each color, to gradation correction processing performed by the gradation correction processing units 23-1 and 23-2, respectively. In the present exemplary embodiment, each gradation correction processing unit performs signal value conversion on multi-valued data in such a way as to obtain a linear relationship between a signal value of the multi-valued data and a density value expressed on a recording medium.

As a result, first multi-valued data 24-1 (C1′, M1′, Y1′, K1′) and second multi-valued data 24-2 (C2′, M2′, Y2′, K2′) can be obtained. The control unit 3000 performs the following processing for each of cyan (C), magenta (M), yellow (Y), and black (K) independently in parallel with each other, although the following description is limited to the black (K) color only.

Subsequently, the quantization processing units 25-1 and 25-2 perform independent binarization processing (quantization processing) on the first multi-valued data 24-1 (K1′) and the second multi-valued data 24-2 (K2′), non-correlatively.

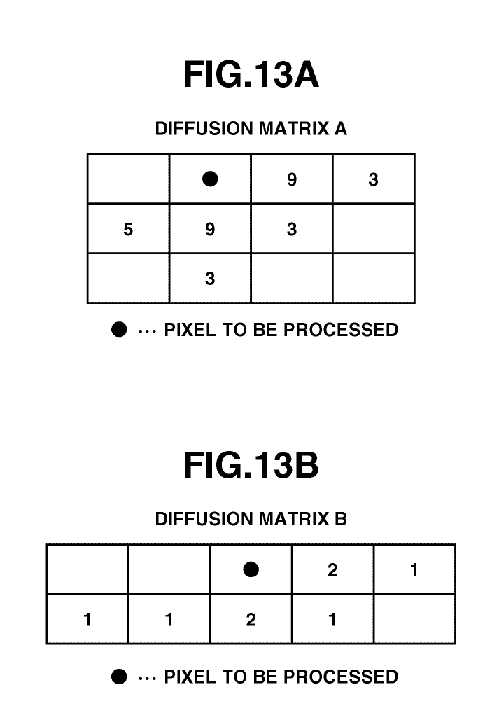

More specifically, the quantization processing unit 25-1 performs conventionally-known error diffusion processing on the first multi-valued data 24-1 (K1′) with reference to an error diffusion matrix illustrated in FIG. 13A and a predetermined quantization threshold to generate a first binary data K1″ (i.e., first quantized data) 26-1. Similarly, the quantization processing unit 25-2 performs conventionally-known error diffusion processing on the second multi-valued data 24-2 (K2′) with reference to an error diffusion matrix illustrated in FIG. 13B and a predetermined quantization threshold to generate a second binary data K2″ (i.e., second quantized data) 26-2.

When the error diffusion matrix to be used for the first multi-valued data is differentiated from the error diffusion matrix to be used for the second multi-valued data as described above, pixels where dots are recorded in both scanning operations and pixels where dots are recorded in only one scanning operation can be both present.

In this case, if the K1″ and K2″ values of a pixel are both 1, two recorded dots are overlapped with each other for the pixel. If the K1″ and K2″ values of a pixel are both 0, no dot is recorded for the pixel. Further, if either one of the K1″ and K2″ values of a pixel is 1, only one dot is recorded for the pixel.

As described above, the quantization processing units 25-1 and 25-2 perform quantization processing on the first and second multi-valued image data (24-1 and 24-2) respectively, for each pixel, to generate the plurality of quantized data (26-1 and 26-2) of the same color. In this respect, the quantization processing units 25-1 and 25-2 can be referred to as a “second generation unit.”

If the binary image data K1″ and K2″ can be obtained by the quantization processing units 25-1 and 25-2 as described above, these data K1″ and K2″ are respectively transmitted to the printer engine 3004 via the IEEE1284 bus 3022 as illustrated in FIG. 3. The printer engine 3004 performs the subsequent processing.

In the printer engine 3004, the binary image data K1″ (26-1) is divided into two pieces of binary image data corresponding to two scanning operations. More specifically, the binary data division processing unit 27 divides the first binary image data K1″ (26-1) into first binary image data A (28-1) and first binary image data B (28-2).

Then, the first binary image data A (28-1) is allocated, as first scanning binary data 29-1, to the first scanning operation. The first binary image data B (28-2) is allocated, as third scanning binary data 29-3, to the third scanning operation. The data can be recorded in each scanning operation.

On the other hand, the second binary image data K2″ (26-2) is not subjected to any division processing. Therefore, second binary image data (28-3) is identical to the second binary image data K2″ (26-2). The second binary image data K2″ (26-2) is allocated, as second scanning binary image data 29-2, to the second scanning operation and then recorded in the second scanning operation.

The binary data division processing unit 27 according to the present exemplary embodiment is described below in more detail. In the present exemplary embodiment, the binary data division processing unit 27 executes division processing using a mask pattern stored beforehand in the memory (the ROM E1004). The mask pattern is an assembly of numerical data that designates admissive (1) or non-admissive (0) with respect of the recording of binary image data for each pixel. The binary data division processing unit 27 divides the above-described binary image data based on AND calculation between the binary image data and a mask value for each pixel.

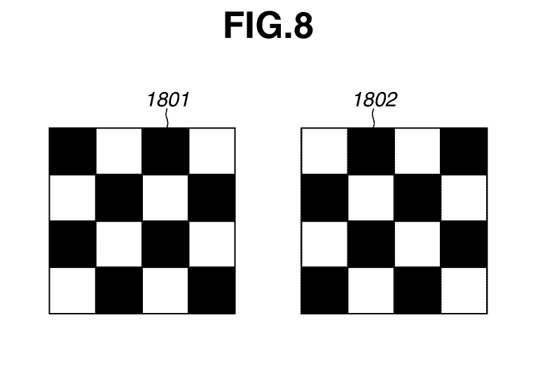

In general, N pieces of mask patterns are used when binary image data is divided into N pieces of data. In the present exemplary embodiment, two masks 1801 and 1802 illustrated in FIG. 8 are used to divide the binary image data into two pieces of data.

In the present exemplary embodiment, the mask 1801 can be used to generate first scanning binary image data, and the mask 1802 can be used to generate second scanning binary image data. The above-described two mask patterns have mutually complementary relationship. Therefore, two divided binary data obtainable through these mask patterns are not overlapped with each other. Accordingly, when dots are recorded by a plurality of nozzle arrays, it is feasible to prevent the recorded dots from overlapping with each other on a recording paper. It is feasible to suppress deterioration in the grainy effect, compared to the above-described dot overlapping processing performed between scanning operations.

In FIG. 8, each black portion indicates an admissive area where recording of image data is feasible (1: an area where image data is not masked), and each white portion indicates a non-admissive area where recording of image data is infeasible (0: an area where image data is masked).

The binary data division processing unit 27 performs division processing using the above-described masks 1801 and 1802. More specifically, the binary data division processing unit 27 generates first scanning binary data 28-1 based on AND calculation between the binary data K1″ (26-1) and the mask 1801 for each pixel. Similarly, the binary data division processing unit 27 generates second scanning binary data 28-3 based on AND calculation between the binary data K1″ (26-1) and the mask 1802 for each pixel.

As described above, the division processing unit 27 generates same color quantized data in a mutually complementary relationship that correspond to at least two scanning and recording operations, from a plurality of same color quantized data. In this respect, the division processing unit 27 can be referred to as “third generation unit.”

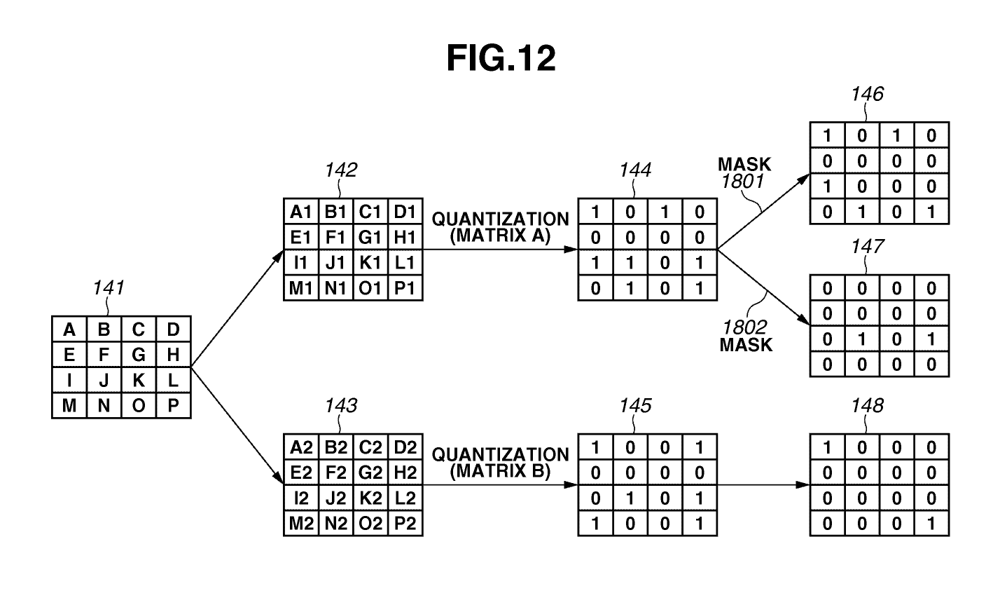

Hereinafter, the image processing illustrated in FIG. 21 is described below in more detail with reference to FIG. 12. FIG. 12 illustrates a practical example of the image processing illustrated in FIG. 21. In the present exemplary embodiment, input image data 141 to be processed includes a total of sixteen pixels of 4 pixels×4 pixels.

In FIG. 12, signs “A” to “P” represent an example combination of RGB values of the input image data 141, which corresponds to each pixel. Signs “A1” to “P1” represent an example combination of CMYK values of first multi-valued image data 142, which corresponds to each pixel. Signs “A2” to “P2” represent an example combination of CMYK values of second multi-valued image data 143, which corresponds to each pixel.

In FIG. 12, the first multi-valued image data 142 corresponds to the first multi-valued data 24-1 illustrated in FIG. 21. The second multi-valued image data 143 corresponds to the second multi-valued data 24-2 illustrated in FIG. 21. Further, first quantized data 144 corresponds to the first binary data 26-1 illustrated in FIG. 21. Second quantized data 145 corresponds to the second binary data 26-2 illustrated in FIG. 21.

Further, first scanning quantized data 146 corresponds to the binary data 28-1 illustrated in FIG. 21. Scanning quantized data 147 corresponds to the binary data 28-2 illustrated in FIG. 21. Further, third scanning quantized data 148 corresponds to the binary data 28-3 illustrated in FIG. 21.

First, the input image data 141 (i.e., RGB data) is input to the color conversion/image data dividing unit 22 illustrated in FIG. 21. Then, the color conversion/image data dividing unit 22 converts the input image data 141 (i.e., RGB data), for each pixel, into the first multi-valued image data 142 (i.e., CMYK data) and the second multi-valued image data 143 (i.e., CMYK data) with reference to the three-dimensional LUT.

In the present exemplary embodiment, the above-described distribution into the first multi-valued image data 142 and the second multi-valued image data 143 is performed in such a manner that the first multi-valued image data 142 (i.e., CMYK data) becomes equal to or less than two times the second multi-valued image data 143 (i.e., CMYK data).

In the present exemplary embodiment, the input image data 141 (RGB data) is separated into the first multi-valued image data 142 and the second multi-valued image data 143 at the ratio of 3:2. For example, if the input image data indicated by the sign A has RGB values (RGB)=(0, 0, 0), the multi-valued image data 142 indicated by the sign A1 has CMYK values (C1, M1, Y1, K1)=(0, 0, 0, 153).

Further, the multi-valued image data 143 indicated by the sign A2 has CMYK values (C2, M2, Y2, K2)=(0, 0, 0, 102). As described above, the color conversion/image data dividing unit 22 generates two multi-valued image data (142 and 143) based on the input image data 141.

The subsequent processing (i.e., gradation correction processing, quantization processing, and mask processing) is performed for each of the CMYK colors independently in parallel with each other, although the following description is limited to only one color (K).

The first and second multi-valued image data (142, 143) having been obtained in the manner described above is input to the quantization unit 25 illustrated in FIG. 21. The quantization unit 25-1 independently performs error diffusion processing on the first multi-valued image data 142 and generates the first quantized data 144. The quantization unit 25-2 independently performs error diffusion processing on the second multi-valued image data 143 and generates the second quantized data 145.

More specifically, as described above, the quantization unit 25-1 uses the predetermined threshold and the error diffusion matrix A illustrated in FIG. 13A when the error diffusion processing is performed on the first multi-valued image data 142, and generates the first quantized binary data 144.

Similarly, as described above, the quantization unit 25-2 uses the predetermined threshold and the error diffusion matrix B illustrated in FIG. 13B when the error diffusion processing is performed on the second multi-valued image data 143, and generates the second quantized binary data 145.

The first quantized data 144 and the second quantized data 145 include a data “1” indicating that a dot is recorded (i.e., an ink is discharged) and a data “0” indicating that no dot is recorded (i.e., no ink is discharged).

Subsequently, the binary data division processing unit 27 divides the first quantized data 144 with the mask patterns to generate first quantized data A 146 corresponding to the first scanning operation and first quantized data B 147 corresponding to the third scanning operation. More specifically, the binary data division processing unit 27 obtains the first quantized data A 146 corresponding to the first scanning operation by thinning the first quantized data 144 with the mask 1801 illustrated in FIG. 8.

Further, the binary data division processing unit 27 obtains the second quantized data B 147 by thinning the first quantized data 144 with the mask 1802 illustrated in FIG. 8. On the other hand, the second quantized data 145 can be directly used, as second scanning quantized data 148, in the subsequent processing. As described above, three types of binary data 146 to 148 can be generated through three scanning and recording operations.

In the present exemplary embodiment, the inkjet recording head 5004 includes the first black nozzle array 54 and the second black nozzle array 55 as two nozzle arrays (i.e., recording element groups) capable of discharging the black ink. Therefore, the first quantized data A 146, the first quantized data B 147, and the second quantized data 148 are respectively separated into binary data for the first black nozzle array and binary data for the second black nozzle array, through the mask processing. More specifically, the binary data division processing unit 27 generates first quantized data A for the first black nozzle array and first quantized data B for the second black nozzle array, from the first quantized data A 146, using the masks 1801 and 1802 having the mutually complementary relationship illustrated in FIG. 8.

Further, the binary data division processing unit 27 generates first quantized data B for the first black nozzle array and first quantized data B for the second black nozzle array, from the first quantized data B 147. The binary data division processing unit 27 generates second quantized data for the first black nozzle array and second quantized data for the second black nozzle array, from the second quantized data 148. However, if there is only one black nozzle array is provided on the inkjet recording head 5004, the above-described processing is not required.

In the present exemplary embodiment, two mask patterns having the mutually complementary relationship are used to generate two pieces of binary data corresponding to two scanning operations. Therefore, the above-described dot overlapping processing is not applied to these scanning operations. Needless to say, it is feasible to apply the dot overlapping processing to all scanning operations as discussed in the conventional method. However, if the dot overlapping processing is applied to all scanning operations, the number of target data to be subjected to the quantization processing increases greatly and the processing load required for the data processing increases correspondingly.

From the above-described reason, in the present exemplary embodiment, in three multi-pass recording operations, two pieces of multi-valued data are generated from input image data, and the dot overlapping processing is applied to the two pieces of generated multi-valued data.

As described above, according to the processing illustrated in FIG. 12, if binary image data 145 and 144 are placed one upon another, there is a portion where two dots are overlapped with each other (i.e., a pixel at which “1” is present in both planes). Therefore, an image robust against the density variation can be obtained.

In the present exemplary embodiment, the first scanning quantized data and the third scanning quantized data are generated from the binary image data 144 through the mask processing. The binary image data 145 is directly used as the second scanning quantized data. In a case where a deviation in the recording position occurs between the first scanning operation and the second scanning operation due to a conveyance error, if the first scanning quantized data and the second scanning quantized data are placed one upon another, there is a portion where two dots are overlapped with each other. Therefore, an image robust against the density variation can be obtained.

Further, in a case where a deviation in the recording position occurs between the second scanning operation and the third scanning operation due to a conveyance error, if the second scanning quantized data and the third scanning quantized data are placed one upon another, there is a portion where two dots are overlapped with each other. Therefore, an image robust against the density variation can be obtained.

Further, in three multi-pass recording operations, two pieces of multi-valued data are generated from input image data, and the dot overlapping processing is applied to the two pieces of generated multi-valued data. It is feasible to suppress the density variation while reducing the processing load required for the dot overlapping processing.

Further, according to the present exemplary embodiment, the mask patterns having the mutually complementary relationship are used to generate data corresponding to the scanning operation that are not subjected to the dot overlapping processing (e.g., the first scanning operation and the second scanning operation in the present exemplary embodiment). Therefore, it is feasible to prevent the scanned and recorded dots from overlapping with each other on a recording paper. It is feasible to suppress deterioration in the grainy effect.

Now, referring back to FIG. 21, a characteristic part of the present exemplary embodiment is described below.

In a conventional multi-pass recording operation, as discussed in Japanese Patent Application Laid-Open No. 2002-96455, a method for setting a recording admission rate (i.e., rate of recording admissive pixels among all pixels) for a mask pattern to be applied to an edge portion of a recording element group (i.e., a nozzle array) to be lower than a recording admission rate for a mask pattern to be applied to a central portion thereof is proposed. Employing the above-described conventional method is useful to prevent an image from containing a defective part, such as a streak.

Hence, in the present exemplary embodiment, the following arrangement is employed to set a recording duty (i.e., rate of recording performed pixels among all pixels) at an edge portion of the recording element group (i.e., the nozzle array) to be lower than a recording duty at a central portion thereof. More specifically, when the input multi-valued image data is separated into the first multi-valued data and the second multi-valued data, the value of the first multi-valued data 24-1 corresponding to the first scanning operation and the third scanning operation is set to be smaller than two times the value of the second multi-valued data 24-2 corresponding to the second scanning operation, in each pixel.

More specifically, in the present exemplary embodiment, the input multi-valued image data is divided into the first multi-valued image data and the second multi-valued image data at the ratio of 3:2. If the recording duty of the input multi-valued data is 100%, the data distribution is performed in such a way as to set the recording duty of the first multi-valued data to be 60% and set the recording duty of the second multi-valued data to be 40%.

Then, after the quantization processing performed on the first multi-valued data and the second multi-valued data is completed, the binary data dividing unit 27 uniformly divides the first binary data 26-1 into the first binary data A corresponding to the first scanning operation and the first binary data B corresponding to the third scanning operation.

Therefore, when the recording duty of the first multi-valued data is 60%, the recording duty of the first binary data A is equal to 30% and the recording duty of the first binary data B is equal to 30%. Further, when the recording duty of the second multi-valued data is 40%, the recording duty of the second binary data remains at 40%. Accordingly, the recording duty at an edge portion of the recording element group corresponding to the first scanning operation and the third scanning operation becomes lower than the recording duty at a central portion of the recording element group corresponding to the second scanning operation.

As described above, the present exemplary embodiment can prevent an image from containing a defective part, such as a streak, because the processing load required for the dot overlapping processing can be reduced and the recording duty at an edge portion of the recording element group is lower than the recording duty at a central portion of the recording element group.

As an example method for lowering the recording duty of an edge portion of the recording element group, the color conversion/image data dividing unit and the gradation correction processing unit may be configured to lower the recording duty of the edge portion. However, the processing load becomes larger, compared to the above-described mask processing. Moreover, if the multi-valued data 24-1 and 24-2 that are greatly different in density difference (i.e., different in data value) are subjected to quantization processing, defective dots (e.g., offset dot output or continuous dots) may occur in a quantization result of the multi-valued data having a smaller data value (i.e., a smaller recording duty).

Therefore, as a method for setting a lower recording duty at an edge portion, as described in the present exemplary embodiment, it is desired to quantize input multi-valued data having been processed by the color conversion/image data dividing unit and divide binary data having a larger data value (i.e., a higher recording duty) with a mask pattern.

In the present exemplary embodiment, the division processing includes thinning quantized data with mask patterns. However, using the mask patterns in the division processing is not essential.

For example, the division processing can include extracting even number column data and odd number column data from quantized data. In this case, the even number column data and the odd number column data can be extracted from first quantized data. Either the even number column data or the odd number column data can be regarded as first scanning quantized data. The other can be regarded as the third scanning quantized data. Compared to the conventional method, the above-described data extraction method can reduce the processing load required for the data processing.

As described above, the present exemplary embodiment can suppress the density variation that may be induced by a deviation in the recording position between three relative movements of the recording head that performs recording in the same area. Further, compared to the conventional method including the quantization of multi-valued image data on three planes, the present exemplary embodiment can reduce the number of target data to be subjected to the quantization processing. Therefore, the present exemplary embodiment can reduce the processing load required for the quantization processing compared to the conventional method.

Further, the present exemplary embodiment can prevent an image from containing a defective part, such as a streak, because the recording duty at an edge portion of a recording element group is set to be lower than the recording duty at a central portion of the recording element group.

Although the present exemplary embodiment has been described based on the 3-pass recording processing, the present invention is not limited to the above-described pass number.

In the present exemplary embodiment, it is important to quantize N (N being an integer equal to or greater than 2 and smaller than M) pieces of same color multi-valued data and then generate a plurality of quantized data having a mutually complementary relationship that correspond to a plurality of scanning operations, from at least one piece of these quantized data, in the M-pass recording operation, (M being an integer equal to or greater than 3). Further, the present exemplary embodiment does not require any quantization processing in the generation of M pieces of data corresponding to the M scanning operations. Therefore, the present exemplary embodiment can reduce the processing load required for the above-described data processing.

Further, the method for lowering the recording duty at an edge portion of the recording element group compared to the recording duty at a central portion thereof is not limited to the above-described method. For example, the distribution of the multi-valued data can be performed in such a way as to set the recording duty of the first multi-valued data to be 70% and set the recording duty of the second multi-valued data to be 30%.

Then, after the first multi-valued data and the second multi-valued data have been subjected to the quantization processing respectively, the binary data dividing unit 27 divides the binary data into the first binary data A and the first binary data B in such a manner that the recording duty of the first binary data A becomes 30% and the recording duty of the first binary data B becomes 40%. In the present exemplary embodiment, the first binary data A is allocated, as the first scanning binary data, to the first scanning operation, and the first binary data B is allocated, as the second scanning binary data, to the second scanning operation.

Further, as the recording duty of the second multi-valued data is 30%, the recording duty of the second binary data remains at 30%. The second binary data is allocated, as the third scanning binary data, to the third scanning operation. Therefore, according to the above-described method, the recording duty becomes 30% in the first scanning operation and in the third scanning operation, which correspond to the edge portion of the recording element group. The recording duty becomes 40% in the second scanning operation, which corresponds to the central portion of the recording element group. In other words, the present exemplary embodiment can prevent an image from containing a defective part, such as a streak, by setting the recording duty at an edge portion of the recording element group to be lower that the recording duty at a central portion of the recording element group.

As understood from the foregoing description, the allocation of the first binary data A, the first binary data B, and the second binary data to respective scanning operations is not limited to the specific example in the above-described exemplary embodiment. The division processing in the above-described exemplary embodiment includes generating the first binary image data A and the first binary image data B from the first binary image data. The first binary image data A is allocated to the first scanning operation. The first binary image data B is allocated to the third scanning operation. Further, the second binary image data is allocated to the second scanning operation.

However, the present invention is not limited to the above-described example. For example, it is useful to allocate the first binary image data A to the first scanning operation, allocate the first binary image data B to the second scanning operation, and allocate the second binary image data to the third scanning operation.

In the above-described first exemplary embodiment, the quantization of the first multi-valued data 24-1 by the quantization processing unit 25-1 is not correlated with the quantization of the second multi-valued image data 24-2 by the quantization processing unit 25-2. Accordingly, there is not a correlative relationship between the first binary data 26-1 produced by the quantization processing unit 25-1 and the second binary data 26-2 produced by the quantization processing unit 25-2 (i.e., between a plurality of planes).

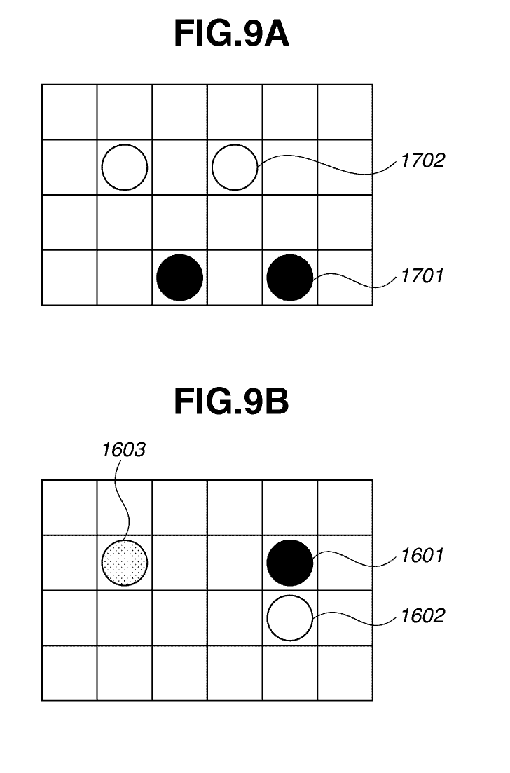

Therefore, the grainy effect may deteriorate because of a large number of overlapped dots. More specifically, from the viewpoint of reducing the grainy effect, it is ideal that a relatively smaller number of dots (1701, 1702) are uniformly decentralized as illustrated in FIG. 9A, at a highlight portion, while maintaining a constant distance between them.

However, if there is not a correlative relationship between binary data on a plurality of planes, two dots may completely overlap with each other (see 1603) or closely recorded (see 1601, 1602) as illustrated in FIG. 9B. When the dots are irregularly disposed, the grainy effect may deteriorate.

In a second exemplary embodiment, to suppress deterioration in the grainy effect, the quantization processing units 25-1 and 25-2 illustrated in FIG. 21 perform quantization processing while correlating the first multi-valued data 24-1 with the second multi-valued image data 24-2. More specifically, the quantization processing units according to the present exemplary embodiment use the second multi-valued data to perform quantization processing on the first multi-valued data and use the first multi-valued data to perform quantization processing on the second multi-valued data.

The second exemplary embodiment is highly beneficial for performing control to prevent a dot from being recorded based on the second multi-valued data (or the first multi-valued data) at a pixel where a dot is recorded based on the first multi-valued data (or the second multi-valued data). The present exemplary embodiment can effectively suppress deterioration in the grainy effect that may occur due to overlapped dots. Hereinafter, a second exemplary embodiment of the present invention is described below in detail.

### <Relationship Between Control of Dot Overlapping Rate, Uneven Density, and Grainy Effect>

As described above in the description of the related art and in the problem to be solved by the present invention, if a deviation occurs between a plurality of dots recorded between different scanning operations or by different recording element groups, a recorded image may have a density variation that can be visually recognized as uneven density.

In the present exemplary embodiment, some dots to be recorded in an overlapped fashion at the same position (i.e., the same pixel or the same sub pixel) are prepared beforehand. In this case, if a deviation occurs in the recording position, dots to be disposed adjacent to each other are overlapped in such a way as to increase a blank area. On the other hand, dots to be overlapped are mutually separated in such a way as to decrease a blank area. Thus, even if a deviation occurs in the recording position, it can be expected that an increased blank area can be cancelled by a comparably reduced blank area. More specifically, an increase in density can be cancelled by a comparable reduction in density in such a way as to maintain the density of the entire image at the same level.

However, preparing the overlapped dots beforehand is not desired if it induces deterioration in the grainy effect. For example, in a case where N pieces of dots are recorded while two dots are successively overlapped with each other, the total number of dot recorded positions becomes N/2. The clearance between adjacent dots becomes wider compared to a case where the dots are not overlapped. Accordingly, the spatial frequency of an image formed with overlapped dots shifts toward a lower frequency side compared to the spatial frequency of an image formed with non-overlapped dots.

In general, an image recorded by an inkjet recording apparatus has spatial frequency ranging from a low frequency area in which the response in human visual characteristics tends to become sensitive to a high frequency area in which the response in human visual characteristics tend to become dull. Accordingly, if the dot recording cycle moves to the low frequency side, the grainy effect may be perceived as a defective part of a recorded image.

More specifically, the robustness tends to deteriorate if the grainy effect is suppressed by enhancing the dot dispersibility (i.e., if the dot overlapping rate is lowered). On the other hand, the grainy effect tends to deteriorate if the robustness is enhanced by increasing the dot overlapping rate. It is difficult to satisfy the antithetical requirements simultaneously.

However, there is a certain amount of admissive range (i.e., a range in which a defective part is not visually recognized due to the human visual characteristics) with respect to the above-described two factors of the density change and the grainy effect. Therefore, if it is feasible to adequately adjust the dot overlapping rate in such a way as to suppress the above-described factors within their admissive ranges, an image that does not contain any defective part, such as a streak, can be output.

However, the above-described admissive ranges and the dot diameter/arrangement are variable, for example, depending on various conditions, such as the type of ink, the type of recording medium, and the value of density data. Therefore, the appropriate dot overlapping rate may not be always constant. Accordingly, it is desired to provide a configuration capable of positively controlling (adjusting) the dot overlapping rate according to various conditions.

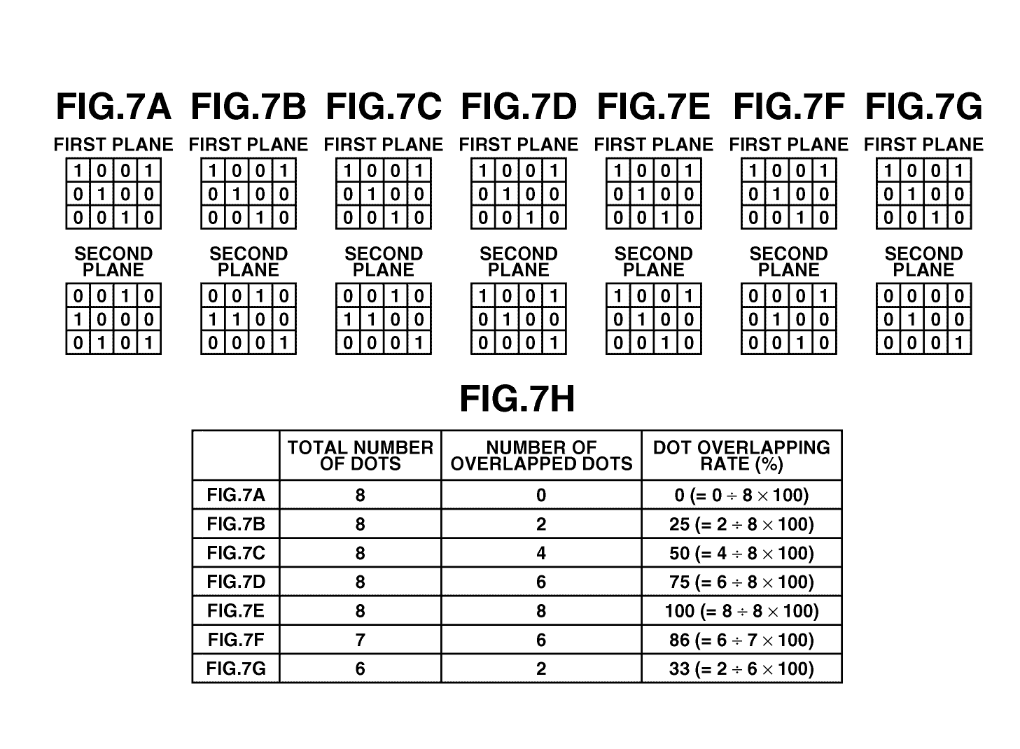

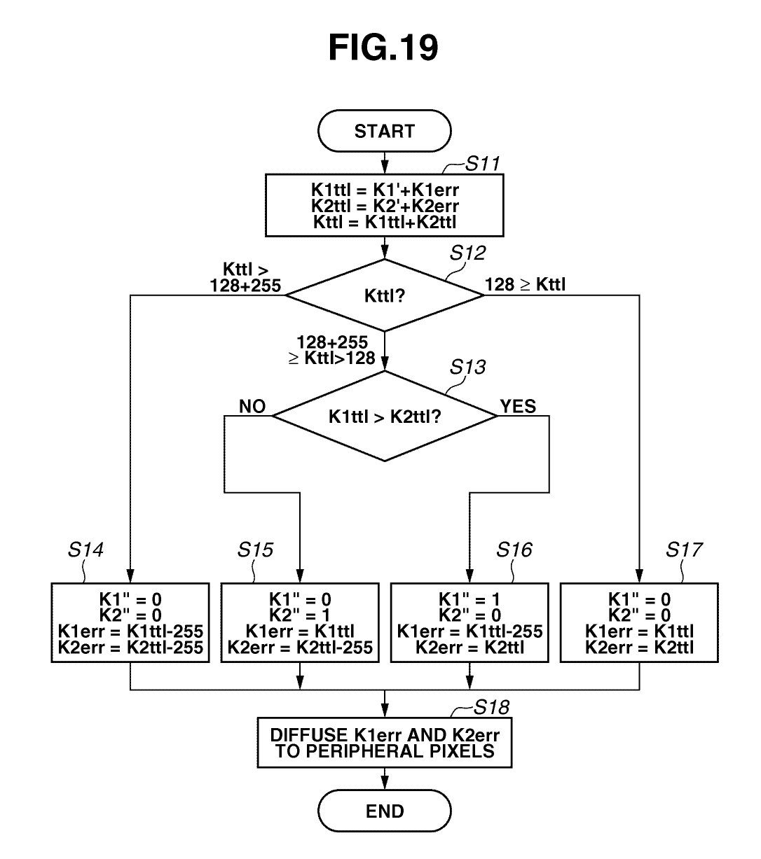

Hereinafter, “the dot overlapping rate” is described in more detail. The “dot overlapping rate” is a ratio of the number of overlapped dots to be recorded in an overlapped fashion at the same position between different scanning operations or by different recording element groups, relative to the total number of dots to be recorded in a unit area constituted by K (K being an integer equal to or greater than 1) pieces of pixel areas, as indicated in FIGS. 7A to 7G or in FIG. 19. The same position can be regarded as the same pixel position in the examples illustrated in FIGS. 7A to 7G and can be regarded as the sub pixel position in the example illustrated in FIG. 19.

Hereinafter, example dot overlapping rates are described below with reference to FIGS. 7A to 7H, which illustrate a first plane and a second plane, each corresponding to a unit area constituted by 4 pixels (in the main scanning direction)×3 pixels (in the sub scanning direction). In the present exemplary embodiment, the “first plane” represents an assembly of binary data that correspond to the first scanning operation or the first nozzle group. The “second plane” represents an assembly of binary data that correspond to the second scanning operation or the second nozzle group. Further, data “1” indicates that a dot is recorded and data “0” indicates that no dot is recorded.

According to the examples illustrated in FIGS. 7A to 7E, the number of data “1” on the first plane is four (i.e., 4) and the number of data “1” on the second plane is also four (i.e., 4). Therefore, the total number of dots to be recorded in the unit area constituted by 4 pixels×3 pixels is eight (i.e., 8). On the other hand, the number of data “1” positioned at the same pixel position on the first plane and the second plane is regarded as the number of overlapped dots to be recorded in an overlapped fashion at the same pixel position.

According to the above-described definition, the number of overlapped dots is zero (i.e., 0) in the case illustrated in FIG. 7A, two (i.e., 2) in the case illustrated in FIG. 7B, four (i.e., 4) in the case illustrated in FIG. 7C, six (i.e., 6) in the case illustrated in FIG. 7D, and eight (i.e., 8) in the case illustrated in FIG. 7E. Accordingly, as illustrated in FIG. 7H, the dot overlapping rates corresponding to the examples illustrated in FIGS. 7A to 7E are 0%, 25%, 50%, 75%, and 100%, respectively.

Examples illustrated in FIGS. 7F and 7G are different from the examples illustrated in FIGS. 7A to 7E in the number of recording dots and the total number of dots on respective planes. According to the example illustrated in FIG. 7F, the number of recording dots on the first plane is four (i.e., 4) and the number of recording dots on the second plane is three (i.e., 3). The total number of the recording dots is seven (i.e., 7). Further, the number of overlapped dots is “six (i.e., 6) and the dot overlapping rate is 86%.

On the other hand, according to the example illustrated in FIG. 7G, the number of recording dots on the first plane is four (i.e., 4) and the number of recording dots on the second plane is two (i.e., 2). The total number of the recording dots is six (i.e., 6). Further, the number of overlapped dots is two (i.e., 2) and the dot overlapping rate is 33%.

As described above, the “dot overlapping rate” defined in the present exemplary embodiment represents an overlapping rate of dot data in a case where the dot data are virtually overlapped between different scanning operations or by different recording element groups, and does not represent an area rate or ratio of overlapped dots on a paper.

### <Image Processing>

Next, example image processing according to the present exemplary embodiment is described below. An image processing configuration according to the present exemplary embodiment is similar to the configuration described in the first exemplary embodiment with reference to FIG. 21. The present exemplary embodiment is different from the first exemplary embodiment in quantization processing to be performed by the quantization processing units 25-1 and 25-2. Therefore, a quantization method peculiar to the present exemplary embodiment is described below in detail, and description of other part is omitted.

Further, to simplify the description in the present and subsequent exemplary embodiments, it is assumed that the inkjet recording head 5004 includes the first black nozzle array 54 as a single black nozzle array. The processing for generating binary data dedicated to the first black nozzle array and binary data dedicated to the second black nozzle array from each scanning binary data is omitted.

Similar to the first exemplary embodiment, the quantization processing units 25-1 and 25-2 illustrated in FIG. 21 receive first multi-valued data 24-1 (K1′) and second multi-valued data 24-2 (K2′), respectively. Then, the quantization processing units 25-1 and 25-2 perform binarization processing (i.e., quantization processing) on the first multi-valued data (K1′) and the second multi-valued data (K2′), respectively. More specifically, each multi-valued data is converted (quantized) into either 0 or 1. Thus, the quantization processing unit 25-1 generates the first binary data K1″ (i.e., first quantized data) 26-1 and the quantization processing unit 25-2 generates the second binary data K2″ (i.e., second quantized data) 26-2.

In this case, if both of the first and second binary data K1″ and K2″ are “1”, two dots are recorded at a corresponding pixel in an overlapped fashion. If both of the first and second binary data K1″ and K2″ are “0”, no dot is recorded at a corresponding pixel. Further, if either one of the first and second binary data K1″ and K2″ is “1”, only one dot is recorded at a corresponding pixel.

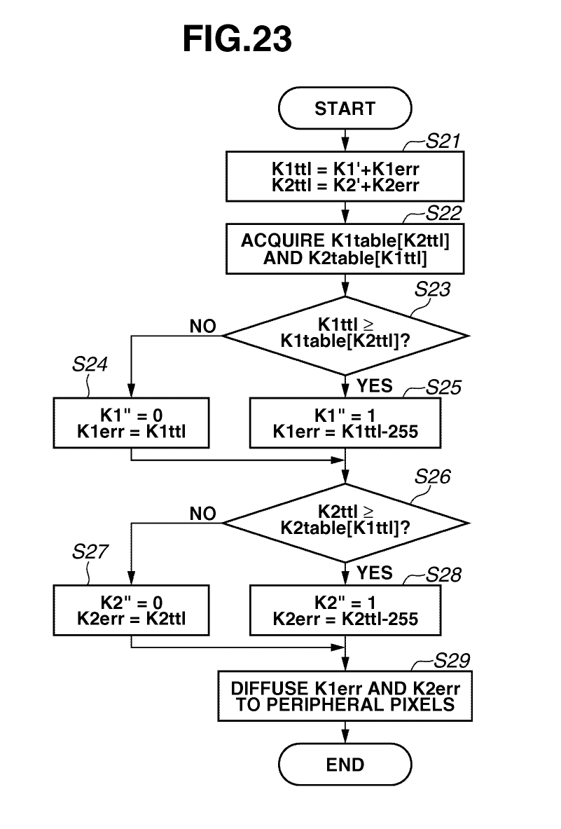

FIG. 23 is a flowchart illustrating an example of the quantization processing that can be executed by the quantization processing units 25-1 and 25-2. In the flowchart illustrated in FIG. 23, each of K1′ and K2′ represents input multi-valued data of a target pixel having a value in a range from 0 to 255. Further, each of K1err and K2err represents a cumulative error value generated from peripheral pixels having been already subjected to the quantization processing. Moreover, each of K1ttl and K2ttl represents a sum of the input multi-valued data and the cumulative error value. K1″ represents first quantized binary data and K2″ represents second quantized binary data.

In the present processing, thresholds (quantization parameters) to be used to determine values of the quantized binary data K1″ and K2″ are variable depending on the values K1ttl and K2ttl. Therefore, a table that can be referred to in uniquely setting appropriate thresholds according the values K1ttl and K2ttl is prepared beforehand

In this case, a threshold to be compared with K1ttl in determining K1″ is referred to as K1table[K2ttl]. A threshold to be compared with K2ttl in determining K2″ is referred to as K2table[K1ttl]. The threshold K1table[K2ttl] takes a value variable depending on the value of K2ttl. The threshold K2table[K1ttl] takes a value variable depending on the value of K1ttl.

If the present processing is started, then in step S21, the quantization processing units 25-1 and 25-2 calculate K1ttl and K2ttl. Next, in step S22, the quantization processing units 25-1 and 25-2 acquire two thresholds K1table[K2ttl] and K2table[K1ttl] based on the values K1ttl and K2ttl obtained in step S21 with reference to a threshold table illustrated in the following table 1.

The threshold K1table[K2ttl] can be uniquely determined using K2ttl as a “reference value” in the threshold table 1. On the other hand, the threshold K2table[K1ttl] can be uniquely determined using K1ttl as a “reference value” in the threshold table 1.

In subsequent steps S23 to S25, the quantization processing unit determines a value of K1″. In steps S26 to S28, the quantization processing unit determines a value of K2″. More specifically, in step S23, the quantization processing unit determine whether the K1ttl value calculated in step S21 is equal to or greater than the threshold K1table[K2ttl] acquired in step S22. If it is determined that the K1ttl value is equal to or greater than the threshold K1table[K2ttl] (YES in step S23), then in step S25, the quantization processing unit sets a value “1” for K1″ (i.e., K1″=1) and calculates a cumulative error value K1err (=K1ttl−255) based on the output value (K1″=1) to update the value K1err. On the other hand, if it is determined that the K1ttl value is less than the threshold K1table[K2ttl] (NO in step S23), then in step S24, the quantization processing unit sets a value “0” for K1″ (i.e., K1″=0) and calculates a cumulative error value K1err (=K1ttl) based on the output value (K1″=0) to update the value K1err.

Next, in step S26, the quantization processing unit determines whether the K2ttl value calculated in step S21 is equal to or greater than the threshold K2table[K1ttl] acquired in step S22. If it is determined that the K2ttl value is equal to or greater than the threshold K2table[K1ttl] (YES in step S26), then in step S28, the quantization processing unit sets a value “1” for K2″ (i.e., K2″=1) and calculates a cumulative error value K2err (=K2ttl−255) based on the output value (K1″=1) to update the value K2err. On the other hand, if it is determined that the K2ttl value is less than the threshold K2table[K1ttl] (NO in step S26), then in step S27, the quantization processing unit sets “0” for K2″(i.e., K2″=0) and calculates a cumulative error value K2err (=K2ttl) based on the output value (K2″=0) to update the value K2ttl.

Subsequently, in step S29, the quantization processing unit diffuses the above-described updated cumulative error values K1err and K2err to peripheral pixels that are not yet subjected to the quantization processing according to the error diffusion matrices illustrated in FIGS. 13A and 13B. In the present exemplary embodiment, the quantization processing unit uses the error diffusion matrix illustrated in FIG. 13A to diffuse the cumulative error value K1err to peripheral pixels. On the other hand, the quantization processing unit uses the error diffusion matrix illustrated in FIG. 13B to diffuse the cumulative error value K2err to peripheral pixels.

As described above, in the present exemplary embodiment, the threshold (quantization parameter) to be used to perform quantization processing on the first multi-valued data (K1ttl) is determined based on the second multi-valued data (K2ttl). Similarly, the threshold (quantization parameter) to be used to perform quantization processing on the second multi-valued data (K2ttl) is determined based on the first multi-valued data (K1ttl).

More specifically, the quantization processing unit executes quantization processing on one multi-valued data and quantization processing on the other multi-valued data based on both of two multi-valued data. Thus, for example, it is feasible to perform a control to prevent a dot from being recorded based on one multi-valued data at a pixel where a dot is recorded based on the other multi-valued data. Therefore, the present exemplary embodiment can suppress deterioration in the grainy effect that may occur due to overlapped dots.

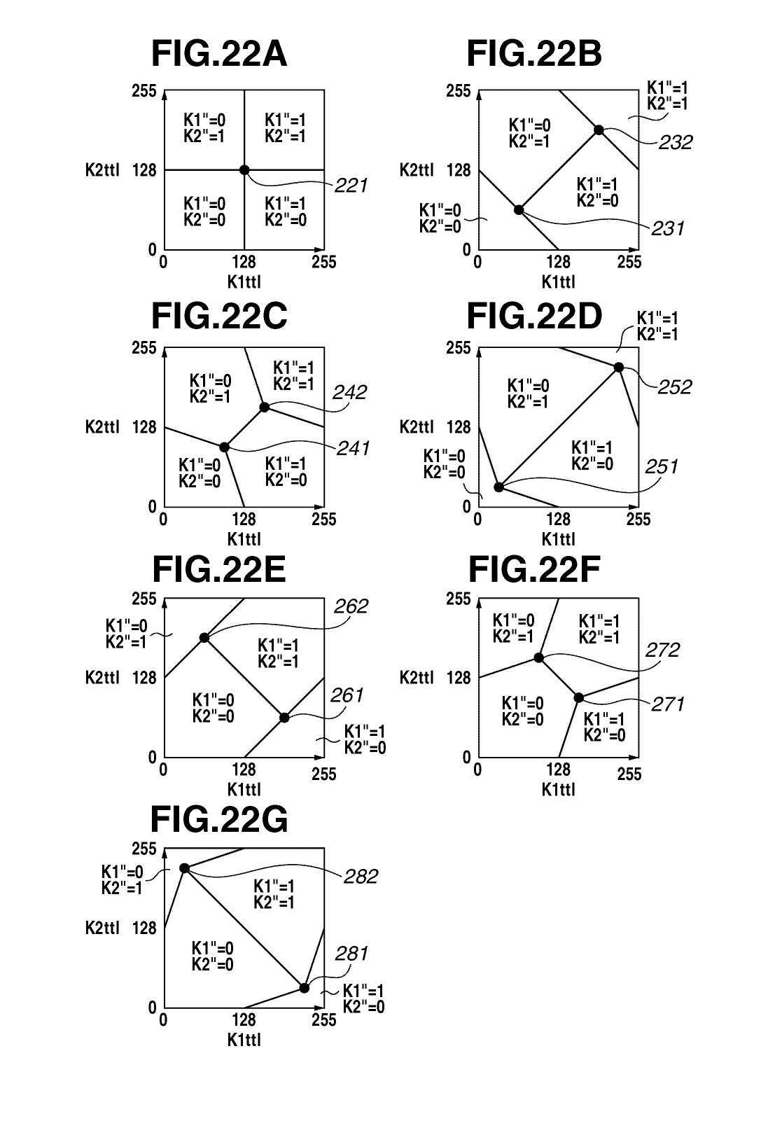

FIG. 22A illustrates an example result of the quantization processing (i.e., the binarization processing) having been performed using threshold data described in a “FIG. 22A” field of the following threshold table 1, according to the flowchart illustrated in FIG. 23, in relation to the input values (K1ttl and K2ttl).

Each of the input values (K1ttl and K2ttl) can take a value in the range from 0 to 255. As illustrated in the “FIG. 22” field of the threshold table, two values of recording (1) and non-recording (0) are determined with reference to a threshold 128. In FIG. 22A, a point 221 is a boundary point between an area where no dot is recorded (K1″=0 and K2″=0) and an area where two dots are overlapped (K1″=1 and K2″=1).

According to the above-described example, the probability of K1″=1 (which can be referred to as “dot recording rate”) is equal to K1′/255 and the probability of K2″=1 is equal to K2′/255. Accordingly, the dot overlapping rate (i.e., the probability that two dots are recorded in an overlapped fashion at a concerned pixel) is substantially equal to (K1′/255)×(K2″/255).

FIG. 22B illustrates a result of the quantization processing (i.e., the binarization processing) having been performed using threshold data described in a “FIG. 22B” field of the following threshold table 1, according to the flowchart illustrated in FIG. 23, in relation to the input values (K1ttl and K2ttl).

In FIG. 22B, a point 231 is a boundary point between an area where no dot is recorded (K1″=0 and K2″=0) and an area where only one dot is recorded (K1″=1 and K2″=0, or K1″=0 and K2″=1). Further, a point 232 is a boundary point between an area where two overlapped dots are recorded (K1″=1 and K2″=1) and the area where only one dot is recorded (K1″=1 and K2″=0, or K1″=0 and K2″=1).

The point 231 and the point 232 are spaced from each other by a certain amount of distance. Therefore, compared to the case illustrated in FIG. 22A, either one of two dots is recorded in a wider area. On the other hand, an area where two dots are both recorded decreases. More specifically, compared to the case illustrated in FIG. 22A, the example illustrated in FIG. 22B is advantageous in that the dot overlapping rate can be reduced and the graininess can be suppressed.

If the dot overlapping rate steeply changes at a specific point as illustrated in FIG. 22A, an uneven density may occur due to a slight change in gradation. However, in the case illustrated in FIG. 22B, the dot overlapping rate smoothly changes according to a change in gradation. Therefore, the occurrence of an uneven density can be suppressed.

In the quantization processing according to the present exemplary embodiment, not only the values of K1″ and K2″ but also the dot overlapping rate can be adjusted in various ways by providing various conditions applied to the value of Kttl and the relationship between K1′ and K2′. Some examples are described below with reference to FIG. 22C to FIG. 22G.

Similar to the above-described FIG. 22A and FIG. 22B, each of FIG. 22C to FIG. 22G illustrates an example result (K1″ and K2″) of the quantization processing having been performed using threshold data described in the following threshold table 1, in relation to the input values (K1ttl and K2ttl).

FIG. 22C illustrates an example in which the dot overlapping rate is set to be somewhere between the value in FIG. 22A and the value in FIG. 22B. In FIG. 22C, a point 241 is set to coincide with a midpoint between the point 221 illustrated in FIG. 22A and the point 231 illustrated in FIG. 22B. Further, a point 242 is set to coincide with a midpoint between the point 221 illustrated in FIG. 22A and the point 232 illustrated in FIG. 22B.

Further, FIG. 22D illustrates an example in which the dot overlapping rate is set to be lower than the value in the example illustrated in FIG. 22B. In FIG. 22D, a point 251 is set to coincide with a point obtainable by externally dividing the point 221 illustrated in FIG. 22A and the point 231 illustrated in FIG. 22B at the ratio of 3:2. Further, a point 252 is set to coincide with a point obtainable by externally dividing the point 221 illustrated in FIG. 22A and the point 232 illustrated in FIG. 22B at the ratio of 3:2.

FIG. 22E illustrates an example in which the dot overlapping rate is set to be larger than the value in the example illustrated in FIG. 22A.

In FIG. 22E, a point 261 is a boundary point between an area where no dot is recorded (K1″=0 and K2″=0), an area where only one dot is recorded (K1″=1 and K2″=0), and an area where two overlapped dots are recorded (K1″=1 and K2″=1). Further, a point 262 is a boundary point between the area where no dot is recorded (K1″=0 and K2″=0), an area where only one dot is recorded (K1″=0 and K2″=1), and the area where two overlapped dots are recorded (K1″=1 and K2″=1).

According to FIG. 22E, a transition from the area where no dot is recorded (K1″=0 and K2″=0) to the area where two overlapped dots are recorded (K1″=1 and K2″=1) easily occurs. Therefore, the dot overlapping rate can be increased.

Further, FIG. 22F illustrates an example in which the dot overlapping rate is set to be somewhere between the value in FIG. 22A and the value in FIG. 22E. In FIG. 22F, a point 271 is set to coincide with a midpoint between the point 221 illustrated in FIG. 22A and the point 261 illustrated in FIG. 22E. Then, a point 272 is set to coincide with a midpoint between the point 221 illustrated in FIG. 22A and the point 262 in FIG. 22E.

Further, FIG. 22G illustrates an example in which the dot overlapping rate is set to be larger than the value in the example illustrated in FIG. 22E. In FIG. 22G, a point 281 is set to coincide with a point obtainable by externally dividing the point 221 illustrated in FIG. 22A and the point 261 illustrated in FIG. 22E at the ratio of 3:2. Then, a point 282 is set to coincide with a point obtainable by externally dividing the point 221 illustrated in FIG. 22A and the point 262 illustrated in FIG. 22E at the ratio of 3:2.

Next, an example quantization processing method using the following threshold table 1 is described below in more detail. The table 1 is a threshold table that can be referred to in step S22 (i.e., the threshold acquiring step) of the flowchart illustrated in FIG. 23, to realize the processing results illustrated in FIGS. 22A to 22G.

In this case, input data (K1ttl, K2ttl)=(100, 120) is used and threshold data described in the “FIG. 22B” field of the threshold table is employed.

First, in step S22 illustrated in FIG. 23, the quantization processing unit obtains the threshold K1table[K2ttl] based on the K2ttl value (reference value) with reference to the threshold table illustrated in the table 1. If the reference value (K2ttl) is “120”, the threshold K1table[K2ttl] is “120.” Similarly, the quantization processing unit obtains the threshold K2table[K1ttl] based on the K1ttl value (reference value) with reference to the threshold table. If the reference value (K1ttl) is “100”, the threshold K2table[K1ttl] is “101.”

Next, in step S23 illustrated in FIG. 23, the quantization processing unit compares the K1ttl value with the threshold K1table[K2ttl]. In this case, the K1ttl value (=100) is smaller than the threshold K1table[K2ttl] (=120). Therefore, in step S24, the quantization processing unit sets 0 for K1″ (i.e., K1″=0).

Similarly, in step S26 illustrated in FIG. 23, the quantization processing unit compares the K2ttl value with the threshold K2table[K1ttl]. In this case, the K2ttl value (=120) is larger than the threshold K2table[K1ttl] (=101). Therefore, in step S28, the quantization processing unit sets 1 for K2″ (i.e., K2″=1). As a result, as illustrated in FIG. 22B, the quantization processing unit can generate a quantization result (K1″, K2″)=(0, 1) from the input data (K1ttl, K2ttl)=(100, 120).

Further, in another example, input value (K1ttl, K2ttl)=(120, 120) is used and threshold data described in the “FIG. 22C” field of the threshold table is employed. In this case, the threshold K1table[K2ttl] is “120” and the threshold K2table[K1ttl] is “121.”

Accordingly, the K1ttl value (=120) is equal to the threshold K1table[K2ttl] (=120). Therefore, the quantization processing unit sets 1 for K1″ (i.e., K1″=1). On the other hand, the K2ttl value (=120) is smaller than the threshold K2table[K1ttl] (=121). Therefore, the quantization processing unit sets 0 for K2″ (i.e., K2″=0). As a result, as illustrated in FIG. 22C, the quantization processing unit can generate a quantization result (K1″, K2″)=(1, 0) from the input data (K1ttl, K2ttl)=(120, 120).

According to the above-described quantization processing, the dot overlapping rate of two multi-valued data can be controlled by quantizing respective multi-valued data based on both of these two multi-valued data. Thus, it becomes feasible to set an appropriate overlapping rate between a dot to be recorded based on one multi-valued data and a dot to be recorded based on the other multi-valued data within an adequate range, in which both of higher robustness and lower graininess can be satisfied.

TABLE 1

| | FIG. 22A | | FIG. 22B | | FIG. 22C | | FIG. 22D | | FIG. 22E | | FIG. 22F | | FIG. 22G | |
|---|---|---|---|---|---|---|---|---|---|---|---|---|---|---|
| Ref | a | b | a | b | a | b | a | b | a | b | a | b | a | b |
| 0 | 128 | 128 | 128 | 128 | 128 | 128 | 128 | 128 | 127 | 127 | 127 | 127 | 127 | 127 |
| 1 | 128 | 128 | 127 | 127 | 127 | 127 | 125 | 125 | 128 | 128 | 128 | 128 | 130 | 130 |
| 2 | 128 | 128 | 126 | 126 | 127 | 127 | 122 | 122 | 129 | 129 | 128 | 128 | 133 | 133 |
| 3 | 128 | 128 | 125 | 125 | 127 | 127 | 119 | 119 | 130 | 130 | 128 | 128 | 136 | 136 |
| 4 | 128 | 128 | 124 | 124 | 126 | 126 | 116 | 116 | 131 | 131 | 129 | 129 | 139 | 139 |
| 5 | 128 | 128 | 123 | 123 | 126 | 126 | 113 | 113 | 132 | 132 | 129 | 129 | 142 | 142 |
| 6 | 128 | 128 | 122 | 122 | 126 | 126 | 110 | 110 | 133 | 133 | 129 | 129 | 145 | 145 |
| 7 | 128 | 128 | 121 | 121 | 125 | 125 | 107 | 107 | 134 | 134 | 130 | 130 | 148 | 148 |
| 8 | 128 | 128 | 120 | 120 | 125 | 125 | 104 | 104 | 135 | 135 | 130 | 130 | 151 | 151 |
| 9 | 128 | 128 | 119 | 119 | 125 | 125 | 101 | 101 | 136 | 136 | 130 | 130 | 154 | 154 |
| 10 | 128 | 128 | 118 | 118 | 124 | 124 | 98 | 98 | 137 | 137 | 131 | 131 | 157 | 157 |
| 11 | 128 | 128 | 117 | 117 | 124 | 124 | 95 | 95 | 138 | 138 | 131 | 131 | 160 | 160 |
| 12 | 128 | 128 | 116 | 116 | 124 | 124 | 92 | 92 | 139 | 139 | 131 | 131 | 163 | 163 |
| 13 | 128 | 128 | 115 | 115 | 123 | 123 | 89 | 89 | 140 | 140 | 132 | 132 | 166 | 166 |
| 14 | 128 | 128 | 114 | 114 | 123 | 123 | 86 | 86 | 141 | 141 | 132 | 132 | 169 | 169 |
| 15 | 128 | 128 | 113 | 113 | 123 | 123 | 83 | 83 | 142 | 142 | 132 | 132 | 172 | 172 |
| 16 | 128 | 128 | 112 | 112 | 122 | 122 | 80 | 80 | 143 | 143 | 133 | 133 | 175 | 175 |
| 17 | 128 | 128 | 111 | 111 | 122 | 122 | 77 | 77 | 144 | 144 | 133 | 133 | 178 | 178 |
| 18 | 128 | 128 | 110 | 110 | 122 | 122 | 74 | 74 | 145 | 145 | 133 | 133 | 181 | 181 |
| 19 | 128 | 128 | 109 | 109 | 121 | 121 | 71 | 71 | 146 | 146 | 134 | 134 | 184 | 184 |
| 20 | 128 | 128 | 108 | 108 | 121 | 121 | 68 | 68 | 147 | 147 | 134 | 134 | 187 | 187 |
| 21 | 128 | 128 | 107 | 107 | 121 | 121 | 65 | 65 | 148 | 148 | 134 | 134 | 190 | 190 |
| 22 | 128 | 128 | 106 | 106 | 120 | 120 | 62 | 62 | 149 | 149 | 135 | 135 | 193 | 193 |
| 23 | 128 | 128 | 105 | 105 | 120 | 120 | 59 | 59 | 150 | 150 | 135 | 135 | 196 | 196 |
| 24 | 128 | 128 | 104 | 104 | 120 | 120 | 56 | 56 | 151 | 151 | 135 | 135 | 199 | 199 |
| 25 | 128 | 128 | 103 | 103 | 119 | 119 | 53 | 53 | 152 | 152 | 136 | 136 | 202 | 202 |
| 26 | 128 | 128 | 102 | 102 | 119 | 119 | 50 | 50 | 153 | 153 | 136 | 136 | 205 | 205 |
| 27 | 128 | 128 | 101 | 101 | 119 | 119 | 47 | 47 | 154 | 154 | 136 | 136 | 208 | 208 |
| 28 | 128 | 128 | 100 | 100 | 118 | 118 | 44 | 44 | 155 | 155 | 137 | 137 | 211 | 211 |
| 29 | 128 | 128 | 99 | 99 | 118 | 118 | 41 | 41 | 156 | 156 | 137 | 137 | 214 | 214 |
| 30 | 128 | 128 | 98 | 98 | 118 | 118 | 38 | 38 | 157 | 157 | 137 | 137 | 217 | 217 |
| 31 | 128 | 128 | 97 | 97 | 117 | 117 | 35 | 35 | 158 | 158 | 138 | 138 | 220 | 220 |
| 32 | 128 | 128 | 96 | 96 | 117 | 117 | 32 | 33 | 159 | 159 | 138 | 138 | 223 | 222 |
| 33 | 128 | 128 | 95 | 95 | 117 | 117 | 33 | 34 | 160 | 160 | 138 | 138 | 222 | 221 |
| 34 | 128 | 128 | 94 | 94 | 116 | 116 | 34 | 35 | 161 | 161 | 139 | 139 | 221 | 220 |
| 35 | 128 | 128 | 93 | 93 | 116 | 116 | 35 | 36 | 162 | 162 | 139 | 139 | 220 | 219 |
| 36 | 128 | 128 | 92 | 92 | 116 | 116 | 36 | 37 | 163 | 163 | 139 | 139 | 219 | 218 |
| 37 | 128 | 128 | 91 | 91 | 115 | 115 | 37 | 38 | 164 | 164 | 140 | 140 | 218 | 217 |
| 38 | 128 | 128 | 90 | 90 | 115 | 115 | 38 | 39 | 165 | 165 | 140 | 140 | 217 | 216 |
| 39 | 128 | 128 | 89 | 89 | 115 | 115 | 39 | 40 | 166 | 166 | 140 | 140 | 216 | 215 |
| 40 | 128 | 128 | 88 | 88 | 114 | 114 | 40 | 41 | 167 | 167 | 141 | 141 | 215 | 214 |
| 41 | 128 | 128 | 87 | 87 | 114 | 114 | 41 | 42 | 168 | 168 | 141 | 141 | 214 | 213 |
| 42 | 128 | 128 | 86 | 86 | 114 | 114 | 42 | 43 | 169 | 169 | 141 | 141 | 213 | 212 |
| 43 | 128 | 128 | 85 | 85 | 113 | 113 | 43 | 44 | 170 | 170 | 142 | 142 | 212 | 211 |
| 44 | 128 | 128 | 84 | 84 | 113 | 113 | 44 | 45 | 171 | 171 | 142 | 142 | 211 | 210 |
| 45 | 128 | 128 | 83 | 83 | 113 | 113 | 45 | 46 | 172 | 172 | 142 | 142 | 210 | 209 |
| 46 | 128 | 128 | 82 | 82 | 112 | 112 | 46 | 47 | 173 | 173 | 143 | 143 | 209 | 208 |
| 47 | 128 | 128 | 81 | 81 | 112 | 112 | 47 | 48 | 174 | 174 | 143 | 143 | 208 | 207 |
| 48 | 128 | 128 | 80 | 80 | 112 | 112 | 48 | 49 | 175 | 175 | 143 | 143 | 207 | 206 |
| 49 | 128 | 128 | 79 | 79 | 111 | 111 | 49 | 50 | 176 | 176 | 144 | 144 | 206 | 205 |
| 50 | 128 | 128 | 78 | 78 | 111 | 111 | 50 | 51 | 177 | 177 | 144 | 144 | 205 | 204 |
| 51 | 128 | 128 | 77 | 77 | 111 | 111 | 51 | 52 | 178 | 178 | 144 | 144 | 204 | 203 |
| 52 | 128 | 128 | 76 | 76 | 110 | 110 | 52 | 53 | 179 | 179 | 145 | 145 | 203 | 202 |
| 53 | 128 | 128 | 75 | 75 | 110 | 110 | 53 | 54 | 180 | 180 | 145 | 145 | 202 | 201 |
| 54 | 128 | 128 | 74 | 74 | 110 | 110 | 54 | 55 | 181 | 181 | 145 | 145 | 201 | 200 |
| 55 | 128 | 128 | 73 | 73 | 109 | 109 | 55 | 56 | 182 | 182 | 146 | 146 | 200 | 199 |
| 56 | 128 | 128 | 72 | 72 | 109 | 109 | 56 | 57 | 183 | 183 | 146 | 146 | 199 | 198 |
| 57 | 128 | 128 | 71 | 71 | 109 | 109 | 57 | 58 | 184 | 184 | 146 | 146 | 198 | 197 |
| 58 | 128 | 128 | 70 | 70 | 108 | 108 | 58 | 59 | 185 | 185 | 147 | 147 | 197 | 196 |
| 59 | 128 | 128 | 69 | 69 | 108 | 108 | 59 | 60 | 186 | 186 | 147 | 147 | 196 | 195 |
| 60 | 128 | 128 | 68 | 68 | 108 | 108 | 60 | 61 | 187 | 187 | 147 | 147 | 195 | 194 |
| 61 | 128 | 128 | 67 | 67 | 107 | 107 | 61 | 62 | 188 | 188 | 148 | 148 | 194 | 193 |
| 62 | 128 | 128 | 66 | 66 | 107 | 107 | 62 | 63 | 189 | 189 | 148 | 148 | 193 | 192 |
| 63 | 128 | 128 | 65 | 65 | 107 | 107 | 63 | 64 | 190 | 190 | 148 | 148 | 192 | 191 |
| 64 | 128 | 128 | 64 | 65 | 106 | 106 | 64 | 65 | 191 | 190 | 149 | 149 | 191 | 190 |
| 65 | 128 | 128 | 65 | 66 | 106 | 106 | 65 | 66 | 190 | 189 | 149 | 149 | 190 | 189 |
| 66 | 128 | 128 | 66 | 67 | 106 | 106 | 66 | 67 | 189 | 188 | 149 | 149 | 189 | 188 |
| 67 | 128 | 128 | 67 | 68 | 105 | 105 | 67 | 68 | 188 | 187 | 150 | 150 | 188 | 187 |
| 68 | 128 | 128 | 68 | 69 | 105 | 105 | 68 | 69 | 187 | 186 | 150 | 150 | 187 | 186 |
| 69 | 128 | 128 | 69 | 70 | 105 | 105 | 69 | 70 | 186 | 185 | 150 | 150 | 186 | 185 |
| 70 | 128 | 128 | 70 | 71 | 104 | 104 | 70 | 71 | 185 | 184 | 151 | 151 | 185 | 184 |
| 71 | 128 | 128 | 71 | 72 | 104 | 104 | 71 | 72 | 184 | 183 | 151 | 151 | 184 | 183 |
| 72 | 128 | 128 | 72 | 73 | 104 | 104 | 72 | 73 | 183 | 182 | 151 | 151 | 183 | 182 |
| 73 | 128 | 128 | 73 | 74 | 103 | 103 | 73 | 74 | 182 | 181 | 152 | 152 | 182 | 181 |
| 74 | 128 | 128 | 74 | 75 | 103 | 103 | 74 | 75 | 181 | 180 | 152 | 152 | 181 | 180 |
| 75 | 128 | 128 | 75 | 76 | 103 | 103 | 75 | 76 | 180 | 179 | 152 | 152 | 180 | 179 |
| 76 | 128 | 128 | 76 | 77 | 102 | 102 | 76 | 77 | 179 | 178 | 153 | 153 | 179 | 178 |
| 77 | 128 | 128 | 77 | 78 | 102 | 102 | 77 | 78 | 178 | 177 | 153 | 153 | 178 | 177 |
| 78 | 128 | 128 | 78 | 79 | 102 | 102 | 78 | 79 | 177 | 176 | 153 | 153 | 177 | 176 |
| 79 | 128 | 128 | 79 | 80 | 101 | 101 | 79 | 80 | 176 | 175 | 154 | 154 | 176 | 175 |
| 80 | 128 | 128 | 80 | 81 | 101 | 101 | 80 | 81 | 175 | 174 | 154 | 154 | 175 | 174 |
| 81 | 128 | 128 | 81 | 82 | 101 | 101 | 81 | 82 | 174 | 173 | 154 | 154 | 174 | 173 |
| 82 | 128 | 128 | 82 | 83 | 100 | 100 | 82 | 83 | 173 | 172 | 155 | 155 | 173 | 172 |
| 83 | 128 | 128 | 83 | 84 | 100 | 100 | 83 | 84 | 172 | 171 | 155 | 155 | 172 | 171 |
| 84 | 128 | 128 | 84 | 85 | 100 | 100 | 84 | 85 | 171 | 170 | 155 | 155 | 171 | 170 |
| 85 | 128 | 128 | 85 | 86 | 99 | 99 | 85 | 86 | 170 | 169 | 156 | 156 | 170 | 169 |
| 86 | 128 | 128 | 86 | 87 | 99 | 99 | 86 | 87 | 169 | 168 | 156 | 156 | 169 | 168 |
| 87 | 128 | 128 | 87 | 88 | 99 | 99 | 87 | 88 | 168 | 167 | 156 | 156 | 168 | 167 |
| 88 | 128 | 128 | 88 | 89 | 98 | 98 | 88 | 89 | 167 | 166 | 157 | 157 | 167 | 166 |
| 89 | 128 | 128 | 89 | 90 | 98 | 98 | 89 | 90 | 166 | 165 | 157 | 157 | 166 | 165 |
| 90 | 128 | 128 | 90 | 91 | 98 | 98 | 90 | 91 | 165 | 164 | 157 | 157 | 165 | 164 |
| 91 | 128 | 128 | 91 | 92 | 97 | 97 | 91 | 92 | 164 | 163 | 158 | 158 | 164 | 163 |
| 92 | 128 | 128 | 92 | 93 | 97 | 97 | 92 | 93 | 163 | 162 | 158 | 158 | 163 | 162 |
| 93 | 128 | 128 | 93 | 94 | 97 | 97 | 93 | 94 | 162 | 161 | 158 | 158 | 162 | 161 |
| 94 | 128 | 128 | 94 | 95 | 96 | 96 | 94 | 95 | 161 | 160 | 159 | 159 | 161 | 160 |
| 95 | 128 | 128 | 95 | 96 | 96 | 96 | 95 | 96 | 160 | 159 | 159 | 159 | 160 | 159 |
| 96 | 128 | 128 | 96 | 97 | 96 | 97 | 96 | 97 | 159 | 158 | 159 | 158 | 159 | 158 |
| 97 | 128 | 128 | 97 | 98 | 97 | 98 | 97 | 98 | 158 | 157 | 158 | 157 | 158 | 157 |
| 98 | 128 | 128 | 98 | 99 | 98 | 99 | 98 | 99 | 157 | 156 | 157 | 156 | 157 | 156 |
| 99 | 128 | 128 | 99 | 100 | 99 | 100 | 99 | 100 | 156 | 155 | 156 | 155 | 156 | 155 |
| 100 | 128 | 128 | 100 | 101 | 100 | 101 | 100 | 101 | 155 | 154 | 155 | 154 | 155 | 154 |
| 101 | 128 | 128 | 101 | 102 | 101 | 102 | 101 | 102 | 154 | 153 | 154 | 153 | 154 | 153 |
| 102 | 128 | 128 | 102 | 103 | 102 | 103 | 102 | 103 | 153 | 152 | 153 | 152 | 153 | 152 |
| 103 | 128 | 128 | 103 | 104 | 103 | 104 | 103 | 104 | 152 | 151 | 152 | 151 | 152 | 151 |
| 104 | 128 | 128 | 104 | 105 | 104 | 105 | 104 | 105 | 151 | 150 | 151 | 150 | 151 | 150 |
| 105 | 128 | 128 | 105 | 106 | 105 | 106 | 105 | 106 | 150 | 149 | 150 | 149 | 150 | 149 |
| 106 | 128 | 128 | 106 | 107 | 106 | 107 | 106 | 107 | 149 | 148 | 149 | 148 | 149 | 148 |
| 107 | 128 | 128 | 107 | 108 | 107 | 108 | 107 | 108 | 148 | 147 | 148 | 147 | 148 | 147 |
| 108 | 128 | 128 | 108 | 109 | 108 | 109 | 108 | 109 | 147 | 146 | 147 | 146 | 147 | 146 |
| 109 | 128 | 128 | 109 | 110 | 109 | 110 | 109 | 110 | 146 | 145 | 146 | 145 | 146 | 145 |
| 110 | 128 | 128 | 110 | 111 | 110 | 111 | 110 | 111 | 145 | 144 | 145 | 144 | 145 | 144 |
| 111 | 128 | 128 | 111 | 112 | 111 | 112 | 111 | 112 | 144 | 143 | 144 | 143 | 144 | 143 |
| 112 | 128 | 128 | 112 | 113 | 112 | 113 | 112 | 113 | 143 | 142 | 143 | 142 | 143 | 142 |
| 113 | 128 | 128 | 113 | 114 | 113 | 114 | 113 | 114 | 142 | 141 | 142 | 141 | 142 | 141 |
| 114 | 128 | 128 | 114 | 115 | 114 | 115 | 114 | 115 | 141 | 140 | 141 | 140 | 141 | 140 |
| 115 | 128 | 128 | 115 | 116 | 115 | 116 | 115 | 116 | 140 | 139 | 140 | 139 | 140 | 139 |
| 116 | 128 | 128 | 116 | 117 | 116 | 117 | 116 | 117 | 139 | 138 | 139 | 138 | 139 | 138 |
| 117 | 128 | 128 | 117 | 118 | 117 | 118 | 117 | 118 | 138 | 137 | 138 | 137 | 138 | 137 |
| 118 | 128 | 128 | 118 | 119 | 118 | 119 | 118 | 119 | 137 | 136 | 137 | 136 | 137 | 136 |
| 119 | 128 | 128 | 119 | 120 | 119 | 120 | 119 | 120 | 136 | 135 | 136 | 135 | 136 | 135 |
| 120 | 128 | 128 | 120 | 121 | 120 | 121 | 120 | 121 | 135 | 134 | 135 | 134 | 135 | 134 |
| 121 | 128 | 128 | 121 | 122 | 121 | 122 | 121 | 122 | 134 | 133 | 134 | 133 | 134 | 133 |
| 122 | 128 | 128 | 122 | 123 | 122 | 123 | 122 | 123 | 133 | 132 | 133 | 132 | 133 | 132 |
| 123 | 128 | 128 | 123 | 124 | 123 | 124 | 123 | 124 | 132 | 131 | 132 | 131 | 132 | 131 |
| 124 | 128 | 128 | 124 | 125 | 124 | 125 | 124 | 125 | 131 | 130 | 131 | 130 | 131 | 130 |
| 125 | 128 | 128 | 125 | 126 | 125 | 126 | 125 | 126 | 130 | 129 | 130 | 129 | 130 | 129 |
| 126 | 128 | 128 | 126 | 127 | 126 | 127 | 126 | 127 | 129 | 128 | 129 | 128 | 129 | 128 |
| 127 | 128 | 128 | 127 | 128 | 127 | 128 | 127 | 128 | 128 | 127 | 128 | 127 | 128 | 127 |
| 128 | 128 | 128 | 128 | 129 | 128 | 129 | 128 | 129 | 127 | 126 | 127 | 126 | 127 | 126 |
| 129 | 128 | 128 | 129 | 130 | 129 | 130 | 129 | 130 | 126 | 125 | 126 | 125 | 126 | 125 |
| 130 | 128 | 128 | 130 | 131 | 130 | 131 | 130 | 131 | 125 | 124 | 125 | 124 | 125 | 124 |
| 131 | 128 | 128 | 131 | 132 | 131 | 132 | 131 | 132 | 124 | 123 | 124 | 123 | 124 | 123 |
| 132 | 128 | 128 | 132 | 133 | 132 | 133 | 132 | 133 | 123 | 122 | 123 | 122 | 123 | 122 |
| 133 | 128 | 128 | 133 | 134 | 133 | 134 | 133 | 134 | 122 | 121 | 122 | 121 | 122 | 121 |
| 134 | 128 | 128 | 134 | 135 | 134 | 135 | 134 | 135 | 121 | 120 | 121 | 120 | 121 | 120 |
| 135 | 128 | 128 | 135 | 136 | 135 | 136 | 135 | 136 | 120 | 119 | 120 | 119 | 120 | 119 |
| 136 | 128 | 128 | 136 | 137 | 136 | 137 | 136 | 137 | 119 | 118 | 119 | 118 | 119 | 118 |
| 137 | 128 | 128 | 137 | 138 | 137 | 138 | 137 | 138 | 118 | 117 | 118 | 117 | 118 | 117 |
| 138 | 128 | 128 | 138 | 139 | 138 | 139 | 138 | 139 | 117 | 116 | 117 | 116 | 117 | 116 |
| 139 | 128 | 128 | 139 | 140 | 139 | 140 | 139 | 140 | 116 | 115 | 116 | 115 | 116 | 115 |
| 140 | 128 | 128 | 140 | 141 | 140 | 141 | 140 | 141 | 115 | 114 | 115 | 114 | 115 | 114 |
| 141 | 128 | 128 | 141 | 142 | 141 | 142 | 141 | 142 | 114 | 113 | 114 | 113 | 114 | 113 |
| 142 | 128 | 128 | 142 | 143 | 142 | 143 | 142 | 143 | 113 | 112 | 113 | 112 | 113 | 112 |
| 143 | 128 | 128 | 143 | 144 | 143 | 144 | 143 | 144 | 112 | 111 | 112 | 111 | 112 | 111 |
| 144 | 128 | 128 | 144 | 145 | 144 | 145 | 144 | 145 | 111 | 110 | 111 | 110 | 111 | 110 |
| 145 | 128 | 128 | 145 | 146 | 145 | 146 | 145 | 146 | 110 | 109 | 110 | 109 | 110 | 109 |
| 146 | 128 | 128 | 146 | 147 | 146 | 147 | 146 | 147 | 109 | 108 | 109 | 108 | 109 | 108 |
| 147 | 128 | 128 | 147 | 148 | 147 | 148 | 147 | 148 | 108 | 107 | 108 | 107 | 108 | 107 |
| 148 | 128 | 128 | 148 | 149 | 148 | 149 | 148 | 149 | 107 | 106 | 107 | 106 | 107 | 106 |
| 149 | 128 | 128 | 149 | 150 | 149 | 150 | 149 | 150 | 106 | 105 | 106 | 105 | 106 | 105 |
| 150 | 128 | 128 | 150 | 151 | 150 | 151 | 150 | 151 | 105 | 104 | 105 | 104 | 105 | 104 |
| 151 | 128 | 128 | 151 | 152 | 151 | 152 | 151 | 152 | 104 | 103 | 104 | 103 | 104 | 103 |
| 152 | 128 | 128 | 152 | 153 | 152 | 153 | 152 | 153 | 103 | 102 | 103 | 102 | 103 | 102 |
| 153 | 128 | 128 | 153 | 154 | 153 | 154 | 153 | 154 | 102 | 101 | 102 | 101 | 102 | 101 |
| 154 | 128 | 128 | 154 | 155 | 154 | 155 | 154 | 155 | 101 | 100 | 101 | 100 | 101 | 100 |
| 155 | 128 | 128 | 155 | 156 | 155 | 156 | 155 | 156 | 100 | 99 | 100 | 99 | 100 | 99 |
| 156 | 128 | 128 | 156 | 157 | 156 | 157 | 156 | 157 | 99 | 98 | 99 | 98 | 99 | 98 |
| 157 | 128 | 128 | 157 | 158 | 157 | 158 | 157 | 158 | 98 | 97 | 98 | 97 | 98 | 97 |
| 158 | 128 | 128 | 158 | 159 | 158 | 159 | 158 | 159 | 97 | 96 | 97 | 96 | 97 | 96 |
| 159 | 128 | 128 | 159 | 160 | 159 | 160 | 159 | 160 | 96 | 95 | 96 | 95 | 96 | 95 |
| 160 | 128 | 128 | 160 | 161 | 160 | 160 | 160 | 161 | 95 | 94 | 95 | 95 | 95 | 94 |
| 161 | 128 | 128 | 161 | 162 | 160 | 160 | 161 | 162 | 94 | 93 | 95 | 95 | 94 | 93 |
| 162 | 128 | 128 | 162 | 163 | 159 | 159 | 162 | 163 | 93 | 92 | 96 | 96 | 93 | 92 |
| 163 | 128 | 128 | 163 | 164 | 159 | 159 | 163 | 164 | 92 | 91 | 96 | 96 | 92 | 91 |
| 164 | 128 | 128 | 164 | 165 | 159 | 159 | 164 | 165 | 91 | 90 | 96 | 96 | 91 | 90 |
| 165 | 128 | 128 | 165 | 166 | 158 | 158 | 165 | 166 | 90 | 89 | 97 | 97 | 90 | 89 |
| 166 | 128 | 128 | 166 | 167 | 158 | 158 | 166 | 167 | 89 | 88 | 97 | 97 | 89 | 88 |
| 167 | 128 | 128 | 167 | 168 | 158 | 158 | 167 | 168 | 88 | 87 | 97 | 97 | 88 | 87 |
| 168 | 128 | 128 | 168 | 169 | 157 | 157 | 168 | 169 | 87 | 86 | 98 | 98 | 87 | 86 |
| 169 | 128 | 128 | 169 | 170 | 157 | 157 | 169 | 170 | 86 | 85 | 98 | 98 | 86 | 85 |
| 170 | 128 | 128 | 170 | 171 | 157 | 157 | 170 | 171 | 85 | 84 | 98 | 98 | 85 | 84 |
| 171 | 128 | 128 | 171 | 172 | 156 | 156 | 171 | 172 | 84 | 83 | 99 | 99 | 84 | 83 |
| 172 | 128 | 128 | 172 | 173 | 156 | 156 | 172 | 173 | 83 | 82 | 99 | 99 | 83 | 82 |
| 173 | 128 | 128 | 173 | 174 | 156 | 156 | 173 | 174 | 82 | 81 | 99 | 99 | 82 | 81 |
| 174 | 128 | 128 | 174 | 175 | 155 | 155 | 174 | 175 | 81 | 80 | 100 | 100 | 81 | 80 |
| 175 | 128 | 128 | 175 | 176 | 155 | 155 | 175 | 176 | 80 | 79 | 100 | 100 | 80 | 79 |
| 176 | 128 | 128 | 176 | 177 | 155 | 155 | 176 | 177 | 79 | 78 | 100 | 100 | 79 | 78 |
| 177 | 128 | 128 | 177 | 178 | 154 | 154 | 177 | 178 | 78 | 77 | 101 | 101 | 78 | 77 |
| 178 | 128 | 128 | 178 | 179 | 154 | 154 | 178 | 179 | 77 | 76 | 101 | 101 | 77 | 76 |
| 179 | 128 | 128 | 179 | 180 | 154 | 154 | 179 | 180 | 76 | 75 | 101 | 101 | 76 | 75 |
| 180 | 128 | 128 | 180 | 181 | 153 | 153 | 180 | 181 | 75 | 74 | 102 | 102 | 75 | 74 |
| 181 | 128 | 128 | 181 | 182 | 153 | 153 | 181 | 182 | 74 | 73 | 102 | 102 | 74 | 73 |
| 182 | 128 | 128 | 182 | 183 | 153 | 153 | 182 | 183 | 73 | 72 | 102 | 102 | 73 | 72 |
| 183 | 128 | 128 | 183 | 184 | 152 | 152 | 183 | 184 | 72 | 71 | 103 | 103 | 72 | 71 |
| 184 | 128 | 128 | 184 | 185 | 152 | 152 | 184 | 185 | 71 | 70 | 103 | 103 | 71 | 70 |
| 185 | 128 | 128 | 185 | 186 | 152 | 152 | 185 | 186 | 70 | 69 | 103 | 103 | 70 | 69 |
| 186 | 128 | 128 | 186 | 187 | 151 | 151 | 186 | 187 | 69 | 68 | 104 | 104 | 69 | 68 |
| 187 | 128 | 128 | 187 | 188 | 151 | 151 | 187 | 188 | 68 | 67 | 104 | 104 | 68 | 67 |
| 188 | 128 | 128 | 188 | 189 | 151 | 151 | 188 | 189 | 67 | 66 | 104 | 104 | 67 | 66 |
| 189 | 128 | 128 | 189 | 190 | 150 | 150 | 189 | 190 | 66 | 65 | 105 | 105 | 66 | 65 |
| 190 | 128 | 128 | 190 | 191 | 150 | 150 | 190 | 191 | 65 | 64 | 105 | 105 | 65 | 64 |
| 191 | 128 | 128 | 191 | 192 | 150 | 150 | 191 | 192 | 64 | 63 | 105 | 105 | 64 | 63 |
| 192 | 128 | 128 | 191 | 191 | 149 | 149 | 192 | 193 | 64 | 64 | 106 | 106 | 63 | 62 |
| 193 | 128 | 128 | 190 | 190 | 149 | 149 | 193 | 194 | 65 | 65 | 106 | 106 | 62 | 61 |
| 194 | 128 | 128 | 189 | 189 | 149 | 149 | 194 | 195 | 66 | 66 | 106 | 106 | 61 | 60 |
| 195 | 128 | 128 | 188 | 188 | 148 | 148 | 195 | 196 | 67 | 67 | 107 | 107 | 60 | 59 |
| 196 | 128 | 128 | 187 | 187 | 148 | 148 | 196 | 197 | 68 | 68 | 107 | 107 | 59 | 58 |
| 197 | 128 | 128 | 186 | 186 | 148 | 148 | 197 | 198 | 69 | 69 | 107 | 107 | 58 | 57 |
| 198 | 128 | 128 | 185 | 185 | 147 | 147 | 198 | 199 | 70 | 70 | 108 | 108 | 57 | 56 |
| 199 | 128 | 128 | 184 | 184 | 147 | 147 | 199 | 200 | 71 | 71 | 108 | 108 | 56 | 55 |
| 200 | 128 | 128 | 183 | 183 | 147 | 147 | 200 | 201 | 72 | 72 | 108 | 108 | 55 | 54 |
| 201 | 128 | 128 | 182 | 182 | 146 | 146 | 201 | 202 | 73 | 73 | 109 | 109 | 54 | 53 |
| 202 | 128 | 128 | 181 | 181 | 146 | 146 | 202 | 203 | 74 | 74 | 109 | 109 | 53 | 52 |
| 203 | 128 | 128 | 180 | 180 | 146 | 146 | 203 | 204 | 75 | 75 | 109 | 109 | 52 | 51 |
| 204 | 128 | 128 | 179 | 179 | 145 | 145 | 204 | 205 | 76 | 76 | 110 | 110 | 51 | 50 |
| 205 | 128 | 128 | 178 | 178 | 145 | 145 | 205 | 206 | 77 | 77 | 110 | 110 | 50 | 49 |
| 206 | 128 | 128 | 177 | 177 | 145 | 145 | 206 | 207 | 78 | 78 | 110 | 110 | 49 | 48 |
| 207 | 128 | 128 | 176 | 176 | 144 | 144 | 207 | 208 | 79 | 79 | 111 | 111 | 48 | 47 |
| 208 | 128 | 128 | 175 | 175 | 144 | 144 | 208 | 209 | 80 | 80 | 111 | 111 | 47 | 46 |
| 209 | 128 | 128 | 174 | 174 | 144 | 144 | 209 | 210 | 81 | 81 | 111 | 111 | 46 | 45 |
| 210 | 128 | 128 | 173 | 173 | 143 | 143 | 210 | 211 | 82 | 82 | 112 | 112 | 45 | 44 |
| 211 | 128 | 128 | 172 | 172 | 143 | 143 | 211 | 212 | 83 | 83 | 112 | 112 | 44 | 43 |
| 212 | 128 | 128 | 171 | 171 | 143 | 143 | 212 | 213 | 84 | 84 | 112 | 112 | 43 | 42 |
| 213 | 128 | 128 | 170 | 170 | 142 | 142 | 213 | 214 | 85 | 85 | 113 | 113 | 42 | 41 |
| 214 | 128 | 128 | 169 | 169 | 142 | 142 | 214 | 215 | 86 | 86 | 113 | 113 | 41 | 40 |
| 215 | 128 | 128 | 168 | 168 | 142 | 142 | 215 | 216 | 87 | 87 | 113 | 113 | 40 | 39 |
| 216 | 128 | 128 | 167 | 167 | 141 | 141 | 216 | 217 | 88 | 88 | 114 | 114 | 39 | 38 |
| 217 | 128 | 128 | 166 | 166 | 141 | 141 | 217 | 218 | 89 | 89 | 114 | 114 | 38 | 37 |
| 218 | 128 | 128 | 165 | 165 | 141 | 141 | 218 | 219 | 90 | 90 | 114 | 114 | 37 | 36 |
| 219 | 128 | 128 | 164 | 164 | 140 | 140 | 219 | 220 | 91 | 91 | 115 | 115 | 36 | 35 |
| 220 | 128 | 128 | 163 | 163 | 140 | 140 | 220 | 221 | 92 | 92 | 115 | 115 | 35 | 34 |
| 221 | 128 | 128 | 162 | 162 | 140 | 140 | 221 | 222 | 93 | 93 | 115 | 115 | 34 | 33 |
| 222 | 128 | 128 | 161 | 161 | 139 | 139 | 222 | 223 | 94 | 94 | 116 | 116 | 33 | 32 |
| 223 | 128 | 128 | 160 | 160 | 139 | 139 | 223 | 224 | 95 | 95 | 116 | 116 | 32 | 31 |
| 224 | 128 | 128 | 159 | 159 | 139 | 139 | 222 | 222 | 96 | 96 | 116 | 116 | 33 | 33 |
| 225 | 128 | 128 | 158 | 158 | 138 | 138 | 219 | 219 | 97 | 97 | 117 | 117 | 36 | 36 |
| 226 | 128 | 128 | 157 | 157 | 138 | 138 | 216 | 216 | 98 | 98 | 117 | 117 | 39 | 39 |
| 227 | 128 | 128 | 156 | 156 | 138 | 138 | 213 | 213 | 99 | 99 | 117 | 117 | 42 | 42 |
| 228 | 128 | 128 | 155 | 155 | 137 | 137 | 210 | 210 | 100 | 100 | 118 | 118 | 45 | 45 |
| 229 | 128 | 128 | 154 | 154 | 137 | 137 | 207 | 207 | 101 | 101 | 118 | 118 | 48 | 48 |
| 230 | 128 | 128 | 153 | 153 | 137 | 137 | 204 | 204 | 102 | 102 | 118 | 118 | 51 | 51 |
| 231 | 128 | 128 | 152 | 152 | 136 | 136 | 201 | 201 | 103 | 103 | 119 | 119 | 54 | 54 |
| 232 | 128 | 128 | 151 | 151 | 136 | 136 | 198 | 198 | 104 | 104 | 119 | 119 | 57 | 57 |
| 233 | 128 | 128 | 150 | 150 | 136 | 136 | 195 | 195 | 105 | 105 | 119 | 119 | 60 | 60 |
| 234 | 128 | 128 | 149 | 149 | 135 | 135 | 192 | 192 | 106 | 106 | 120 | 120 | 63 | 63 |
| 235 | 128 | 128 | 148 | 148 | 135 | 135 | 189 | 189 | 107 | 107 | 120 | 120 | 66 | 66 |
| 236 | 128 | 128 | 147 | 147 | 135 | 135 | 186 | 186 | 108 | 108 | 120 | 120 | 69 | 69 |
| 237 | 128 | 128 | 146 | 146 | 134 | 134 | 183 | 183 | 109 | 109 | 121 | 121 | 72 | 72 |
| 238 | 128 | 128 | 145 | 145 | 134 | 134 | 180 | 180 | 110 | 110 | 121 | 121 | 75 | 75 |
| 239 | 128 | 128 | 144 | 144 | 134 | 134 | 177 | 177 | 111 | 111 | 121 | 121 | 78 | 78 |
| 240 | 128 | 128 | 143 | 143 | 133 | 133 | 174 | 174 | 112 | 112 | 122 | 122 | 81 | 81 |
| 241 | 128 | 128 | 142 | 142 | 133 | 133 | 171 | 171 | 113 | 113 | 122 | 122 | 84 | 84 |
| 242 | 128 | 128 | 141 | 141 | 133 | 133 | 168 | 168 | 114 | 114 | 122 | 122 | 87 | 87 |
| 243 | 128 | 128 | 140 | 140 | 132 | 132 | 165 | 165 | 115 | 115 | 123 | 123 | 90 | 90 |
| 244 | 128 | 128 | 139 | 139 | 132 | 132 | 162 | 162 | 116 | 116 | 123 | 123 | 93 | 93 |
| 245 | 128 | 128 | 138 | 138 | 132 | 132 | 159 | 159 | 117 | 117 | 123 | 123 | 96 | 96 |
| 246 | 128 | 128 | 137 | 137 | 131 | 131 | 156 | 156 | 118 | 118 | 124 | 124 | 99 | 99 |
| 247 | 128 | 128 | 136 | 136 | 131 | 131 | 153 | 153 | 119 | 119 | 124 | 124 | 102 | 102 |
| 248 | 128 | 128 | 135 | 135 | 131 | 131 | 150 | 150 | 120 | 120 | 124 | 124 | 105 | 105 |
| 249 | 128 | 128 | 134 | 134 | 130 | 130 | 147 | 147 | 121 | 121 | 125 | 125 | 108 | 108 |
| 250 | 128 | 128 | 133 | 133 | 130 | 130 | 144 | 144 | 122 | 122 | 125 | 125 | 111 | 111 |
| 251 | 128 | 128 | 132 | 132 | 130 | 130 | 141 | 141 | 123 | 123 | 125 | 125 | 114 | 114 |
| 252 | 128 | 128 | 131 | 131 | 129 | 129 | 138 | 138 | 124 | 124 | 126 | 126 | 117 | 117 |
| 253 | 128 | 128 | 130 | 130 | 129 | 129 | 135 | 135 | 125 | 125 | 126 | 126 | 120 | 120 |
| 254 | 128 | 128 | 129 | 129 | 129 | 129 | 132 | 132 | 126 | 126 | 126 | 126 | 123 | 123 |
| 255 | 128 | 128 | 128 | 128 | 129 | 129 | 129 | 129 | 127 | 127 | 126 | 126 | 126 | 126 |

Ref: reference value, a: K1table, b: K2table

As described above, the quantization processing unit 25-1 generates the first binary data K1″ (i.e., the first quantized data) 26-1. The quantization processing unit 25-2 generates the second scanning binary data K2″ (i.e., the second quantized data) 26-2.

Then, the binary data K1″ (i.e., one of the generated binary data K1″ and K2″) is sent to the division processing unit 27 illustrated in FIG. 21 and subjected to the processing described in the first exemplary embodiment. Thus, the binary data 28-1 and 28-2 corresponding to the first scanning operation and the second scanning operation can be generated.

According to the above-described processing, when two binary data (26-1, 26-2) are placed one upon another, there are some areas where dots are overlapped (i.e., pixels where the value “1” is present on both planes). Therefore, an image robust against the density variation can be obtained. On the other hand, the number of the areas where the dots are overlapped is not so large that the grainy effect deteriorates due to the overlapped dots.

Further, the present exemplary embodiment applies the dot overlapping rate control to specific scanning operations and does not apply the dot overlapping rate control to a plurality of nozzle arrays. Accordingly, the present exemplary embodiment can adequately realize both of uneven density reduction and grainy effect reduction, while reducing the processing load in the dot overlapping rate control.

Further, the present exemplary embodiment can prevent an image from containing a defective part, such as a streak, by setting the recording duty at an edge portion of the recording element group to be lower that the recording duty at a central portion of the recording element group.

The quantization processing according to the above-described exemplary embodiment is the error diffusion processing capable of controlling the dot overlapping rate as described above with reference to FIG. 23. However, the present exemplary embodiment is not limited to the above-described quantization processing. Hereinafter, another example of the quantization processing according to a modified embodiment of the second exemplary embodiment is described below with reference to FIG. 19.

FIG. 19 is a flowchart illustrating an example of an error diffusion method that can be performed by the control unit 3000 to reduce the dot overlapping rate according to the present exemplary embodiment. Parameters used in the flowchart illustrated in FIG. 19 are similar to those illustrated in FIG. 23.

If the control unit 3000 starts quantization processing for a target pixel, first, in step S11, the control unit 3000 calculates K1ttl and K2ttl and adds the calculated values to obtain Kttl (=K1ttl+K2ttl). In this case, Kttl has a value in a range from 0 to 510. In subsequent steps S12 to S17, the control unit 3000 determines values K1″ and K2″ that correspond to quantized binary data with reference to the Kttl value and considering whether K1ttl is greater than K2ttl.

If Kttl>128+255, the processing proceeds to step S14, in which the control unit 3000 sets “1” for K1″ and K2″ (i.e., K1″=1 and K2″=1). Further, if Kttl≦128, the processing proceeds to step S17, in which the control unit 3000 sets “0” for K1″ and K2″ (i.e., K1″=0 and K2″=0). On the other hand, if 128+255≧Kttl>128, the processing proceeds to step S13, in which the control unit 3000 compares K1ttl with K2ttl. If K1ttl>K2ttl (YES in step S13), the processing proceeds to step S16, in which the control unit 3000 sets 1 for K1″ and sets 0 for K2″ (i.e., K1″=1 and K2″=0). If K1ttl K2ttl (NO in step S13), the processing proceeds to step S15, in which the control unit 3000 sets 0 for K1″ and sets 1 for K2″ (i.e., K1″=0 and K2″=1).

In steps S14 to S17, the control unit 3000 newly calculates and updates cumulative error values K1err and K2err according to the determined output values K1″ and K2″. More specifically, if K1″=1, then K1err=K1ttl−255. If K1″=0, then K1err=K1ttl. Similarly, if K2″=1, then K2err=K2ttl−255. If K2″=0, then K2err=K2ttl.

Further, in step S18, the control unit 3000 diffuses the updated cumulative error values K1err and K2err to peripheral pixels that are not yet subjected to the quantization processing, according to a predetermined diffusion matrices (e.g., the diffusion matrices illustrated in FIG. 13). Then, the control unit 3000 completes the processing of the flowchart illustrated in FIG. 19.

In the present exemplary embodiment, the control unit 3000 uses the error diffusion matrix illustrated in FIG. 13A to diffuse the cumulative error value K1err to peripheral pixels and uses the error diffusion matrix illustrated in FIG. 13B to diffuse the cumulative error value K2err to peripheral pixels.

According to the above-described modified embodiment, the control unit 3000 performs quantization processing on first multi-valued image data and also performs quantization processing on second multi-valued image data based on both of the first multi-valued image data and the second multi-valued image data. Thus, it becomes feasible to output an image having a desired dot overlapping rate between two multi-valued image data. A high-quality image excellent in robustness and suppressed in grainy effect can be obtained.

A third exemplary embodiment relates to a mask pattern that can be used by the binary data dividing unit, in which a recording admission rate of the mask pattern is set to become smaller along a direction from a central portion of the recording element group to an edge portion thereof. The mask pattern according to the third exemplary embodiment enables a recording apparatus to form an image whose density change is suppressed, because the recording admission rate is gradually variable along the direction from the central portion of the recording element group to the edge portion thereof. Hereinafter, the present exemplary embodiment is described below in more detail.

The 3-pass recording processing according to the present exemplary embodiment is for completing an image in the same area of a recording medium by performing three scanning and recording operations. Image processing according to the present exemplary embodiment is basically similar to the image processing described in the first exemplary embodiment. The present exemplary embodiment is different from the first exemplary embodiment in a division method for dividing the first binary data into the first binary data A dedicated to the first scanning operation and the first binary data B dedicated to the third scanning.

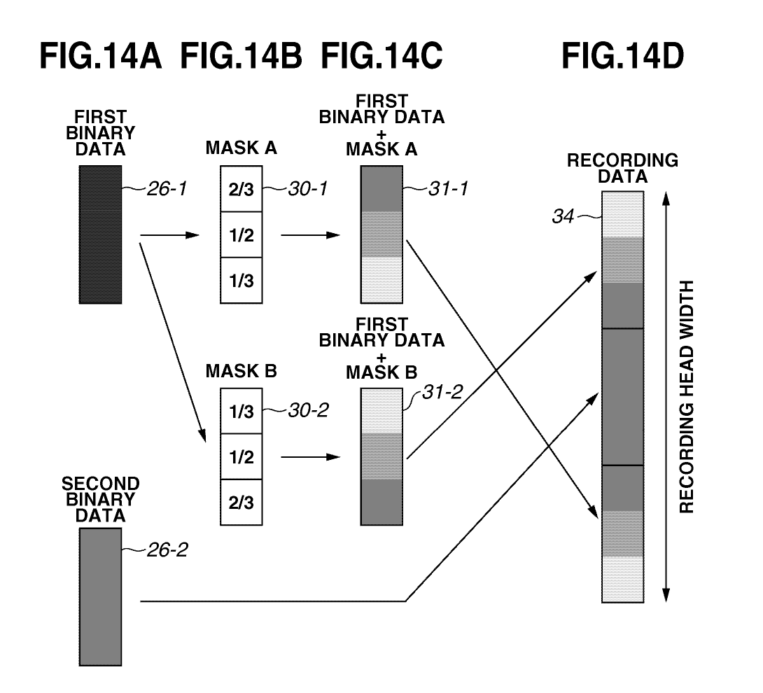

FIGS. 14A to 14D sequentially illustrate generation of first binary data 26-1 and second binary data 26-2, generation of binary data corresponding to each scanning operation, and allocation of the generated binary data to each scanning operation according to the present exemplary embodiment.

FIG. 14A illustrates the first binary data 26-1 generated by the quantization unit 25-1 and the second binary data 26-2 generated by the quantization unit 25-2. FIG. 14B illustrates a mask A that can be used by the binary data dividing unit 27 to generate the first binary data A and a mask B that can be used by the binary data dividing unit 27 to generate the first binary data B.

Then, the binary data dividing unit 27 applies the mask A to the first binary data 26-1 and applies the mask B to the first binary data 26-1, as illustrated in FIG. 14C, to divide the first binary data 26-1 into the first binary data A and the first binary data B. The mask A and the mask B are in an exclusive relationship with respect to the recording admissive pixel position.

In the present exemplary embodiment, the mask A and the mask B that can be used by the binary data dividing unit 27 have the characteristic features. The mask 1801 and the mask 1802 used by the binary data dividing unit 27 in the first exemplary embodiment have a constant recording admission rate in the nozzle arranging direction. On the other hand, the mask A (30-1) according to the present exemplary embodiment is set to have a recording admission rate decreasing along the direction from the central portion of the recording element group to the edge portion thereof (i.e., from top to bottom in FIG. 14B).

More specifically, the mask A includes three same-sized areas disposed sequentially in the nozzle arranging direction, which are set to be ⅔, ½, and ⅓ in the recording admission rate from the central portion of the recording element group. Further, the mask B (30-2) is set to have a recording admission rate decreasing along the direction from the central portion of the recording element group to the edge portion thereof (i.e., from bottom to top in FIG. 14B). More specifically, the mask B includes three same-sized areas disposed sequentially in the nozzle arranging direction, which are set to be ⅔, ½, and ⅓ in the recording admission rate from the central portion of the recording element group. In both of the masks A and B, respective areas to which recording admission rates are set can be divided differently in size.

In the present exemplary embodiment, the image data dividing unit 22 separates multi-valued input data into the first multi-valued data and second multi-valued data at the ratio of 3:2. Therefore, the first multi-valued data (i.e., first binary data) has a recording duty of 60%.

If the mask A illustrated in FIG. 14B is used to generate first binary data A (31-1) from the first binary data, the recording duty can be set to have a gradient defined by 40% (60%×⅔), 30% (60%×½), and 20% (60%×⅓) along the direction from the central portion of the recording element group to the edge portion thereof. Further, if the mask B is used to generate first binary data B (31-2) from the first binary data, the recording duty can be set to have a gradient defined by 40% (60%×⅔), 30% (60%×½), and 20% (60%×⅓) along the direction from the central portion of the recording element group to the edge portion thereof.

Further, as the image data dividing unit 22 separates the multi-valued input data into the first multi-valued data and the second multi-valued data at the ratio of 3:2, the second multi-valued data (i.e., second binary data) has a recording duty of 40%. More specifically, the recording duty at the central portion of the recording element group becomes 40%. The recording duty smoothly changes from 40% to 30%, and to 20% along the direction from the central portion of the recording element group to the edge portion thereof.

FIG. 14D schematically illustrates an allocation of binary data to the recording element group. The lower side of FIG. 14D corresponds to the upstream side in the conveyance direction. The binary data corresponding to a lower one-third is recorded in the first scanning operation. The binary data corresponding to a central one-third is recorded in the second scanning operation. The binary data corresponding to an upper one-third is recorded in the third scanning operation.

In the present exemplary embodiment, the first binary data A (31-1) is allocated to an upstream one-third of the recording element group so that the first binary data A (31-1) can be recorded in the first scanning operation. Further, the second binary data (26-2) is allocated to a central one-third of the recording element group so that the second binary data (26-2) can be recorded in the second scanning. The first binary data B (31-2) is allocated to a downstream one-third of the recording element group so that the first binary data B (31-2) can be recorded in the third scanning operation. When the first to third scanning operations are completed, recording data (34) can be generated in the same predetermined area.

As described above, in the present exemplary embodiment, the recording admission rate of the mask pattern used in the binary data dividing unit is set to decrease along the direction from the central portion of the recording element group to the edge portion thereof. The recording apparatus according to the present exemplary embodiment can record an image whose density change is suppressed because the recording admission rate is gradually variable along the direction from the central portion of the recording element group to the edge portion thereof.

However, if the generated multi-valued data 24-1 and 24-2 are greatly different in density (i.e., in data value) to set the recording duty to be 40% at the central portion of the recording element group and 20% at the edge portion thereof, the following problem may occur. More specifically, as a result of quantization based on the multi-valued data having a smaller value (i.e., a lower recording duty), the dot output may offset or continuous dots may appear.

Further, in a case where the first multi-valued data and the second multi-valued data are quantized based on both of the multi-valued data (as described in the second exemplary embodiment), it is difficult to perform quantization processing in such a way as to set a gradient recording duty while controlling the dot overlapping rate of respective planes. Therefore, complicated processing will be required.

The present exemplary embodiment can prevent an image from containing a defective part, such as a streak, by setting the recording duty at an edge portion of the recording element group to be lower than the recording duty at the central portion of the recording element group, while reducing the quantization processing load.

A configuration according to a modified embodiment of the third exemplary embodiment is basically similar to the configuration described in the third exemplary embodiment and is characterized in a data management method.

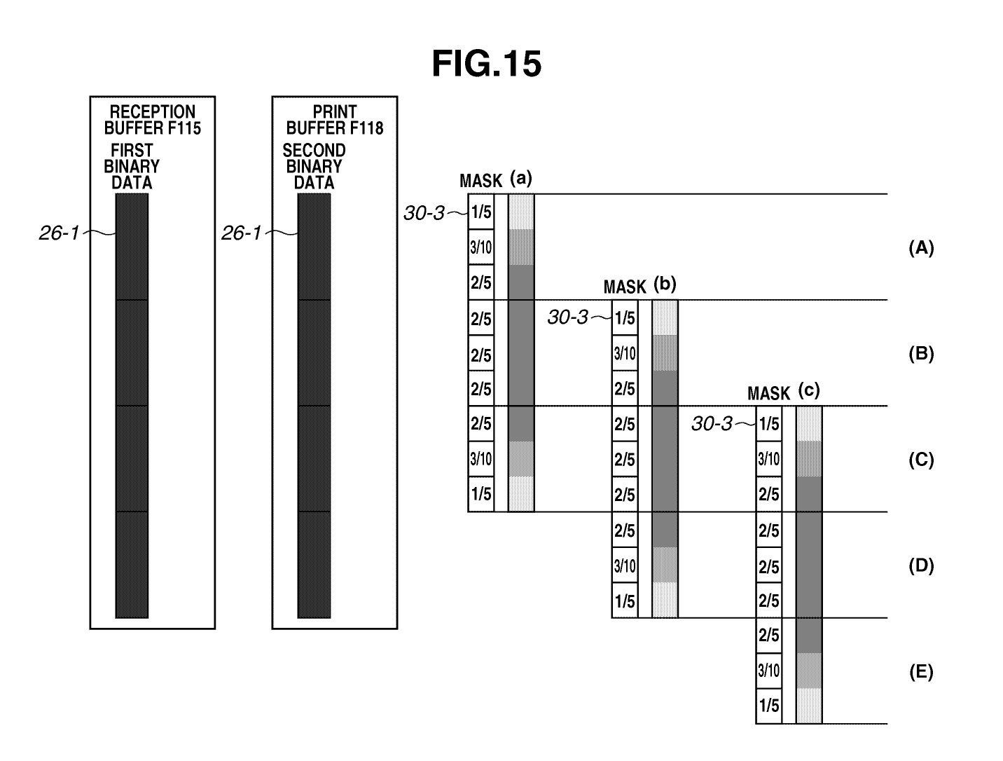

FIG. 15 illustrates a conventional example of the data management method usable to generate binary data corresponding to each scanning operation. Example data illustrated on the left side of FIG. 15 is binary data stored in the reception buffer F115 and the print buffer F118. Further, example data illustrated on the right side of FIG. 15 is binary data generated by a mask 30-3 for each scanning operation performed by the recording element group. In the present exemplary embodiment, the recording element group causes three relative movements according to the 3-pass recording method to form an image in a predetermined area of a recording medium. FIG. 15 illustrates binary data (a), (b), and (c) corresponding to the first to third scanning operations in relation to predetermined areas (A), (B), (C), (D), and (E) of the recording medium.

According to the conventional example illustrated in FIG. 15, one plane of binary data is generated for each color. The generated binary data is stored in the reception buffer F115 and then transferred to the print buffer F118, so that division processing using the mask pattern can be performed based on the transferred binary data. The binary data transferred to the print buffer F118 is converted into the first scanning binary data (a) of the recording element group through AND calculation between the transferred binary data and the mask pattern 30-3.

In the present exemplary embodiment, the recording duty at an edge portion of the recording element group (i.e., the nozzle array) is set to a lower value. To this end, the recording element group includes nine areas disposed sequentially in the nozzle arranging direction. The recording admission rate in each area of the mask pattern is set in the following manner. More specifically, recording admission rates of respective areas are set to be ⅕ (=20%), 3/10 (=30%), ⅖ (=40%), ⅖ (=40%), ⅖ (=40%), ⅖ (=40%), ⅖ (=40%), 3/10 (=30%), and ⅕ (=20%) from an edge portion.

Similarly, the second scanning binary data (b) and the third scanning binary data (c) of the recording element group can be obtained through AND calculation between the binary data stored in the print buffer and the mask 30-3.

The binary data divided into three pieces of data with the above-described mask 30-3 can be recorded in the same predetermined area of a recording medium through three scanning operations of the recording element group. For example, in an upper one-third part of the recording area (C), two fifths (⅖=40%) of the binary data is recorded during the first scanning operation (see (a)). Then, two fifths (⅖=40%) of the binary data is recorded during the second scanning operation (see (b)). Finally, one fifth (⅕=20%) of the binary data is recorded during the third scanning operation (see (c)). As a result, a composite image can be formed in the upper one-third part of the recording area (C).

In this case, the mask patterns employed to divide the binary data corresponding to the same recording area into three pieces of data are mutually exclusive and the sum of their recording admission rates is equal to 1 (=100%). Further, the recording duty in a central one-third part of the recording area (C) is set to be three tenths ( 3/10=30%) in the first scanning operation, two fifths (⅖=40%) in the second scanning operation, and three tenths ( 3/10=30%) in the third scanning operation.

Further, the recording duty in a lower one-third part of the recording area (C) is set to be one fifth (⅕=20%) in the first scanning operation, two fifths (⅖=40%) in the second scanning operation, and two fifths (⅖=40%) in the third scanning operation. As described above, a simple configuration has been conventionally employed to obtain binary data dedicated to each scanning operation of the recording element group based on AND calculation between binary data in the print buffer and an employed mask pattern.

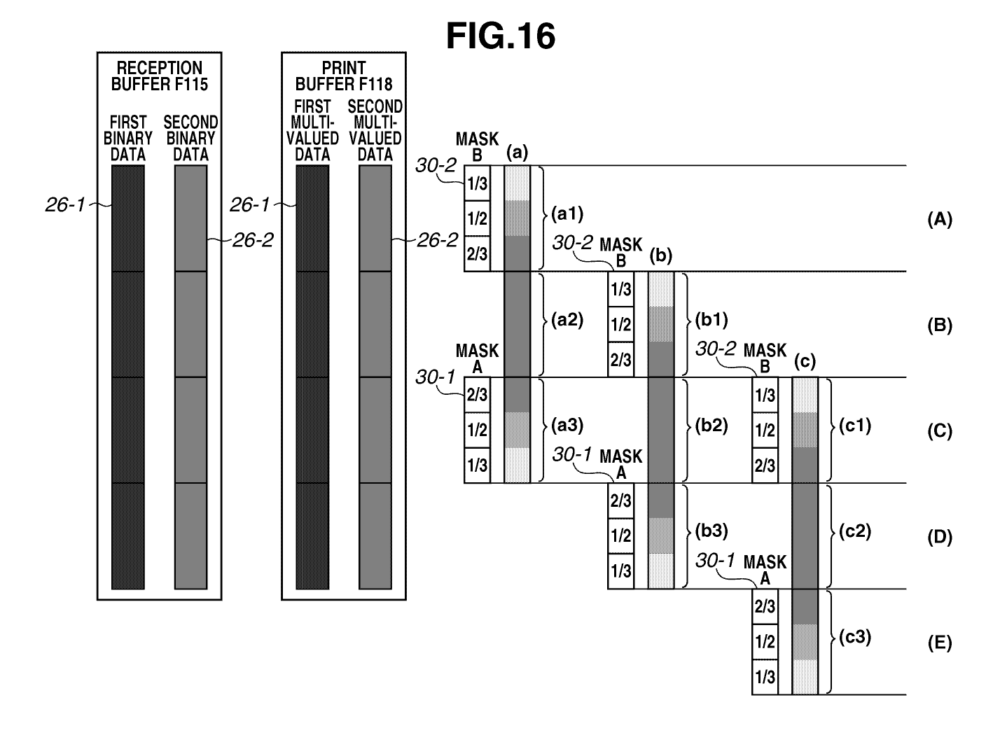

Next, an example division of binary data constituting two planes into binary data corresponding to each scanning according to the above-described conventional data management method is described. Example data illustrated on the left side of FIG. 16 is first binary data 26-1 and second binary data 26-2, which are examples of the binary data constituting two planes stored in the reception buffer F115 and the print buffer F118. Further, example data illustrated on the right side of FIG. 16 is binary data generated by two masks A and B for each scanning operation performed by the recording element group.

In this case, to generate the first scanning binary data (a) of the recording element group, the first binary data is divided into two with the mask patterns and allocated to an upper end portion and a lower end portion of the recording element group. The second binary data is allocated to the central portion of the recording element group. Accordingly, the first scanning binary data (a) includes binary data (a1) generated based on AND calculation between the first binary data B and the mask B (30-2) in its upper one-third portion and binary data (a3) generated based on AND calculation between the first binary data A and the mask A (30-1) in its lower one-third portion.

Further, the first scanning binary data (a) includes binary data (a2), i.e., the second binary data itself, in its central one-third portion. Binary data dedicated to each of the second and subsequent scanning operations of the recording element group can be generated in the same manner.

The mask patterns employed to divide the first binary data are in a mutually exclusive relationship and the sum of their recording admission rates is equal to 1 (=100%). For example, in the upper one-third part of the recording area (C), two thirds (⅔) of the first binary data is recorded during the first scanning operation (see (a)). Then, the remaining one third (⅓) of the first binary data is recorded during the third scanning operation (see (c)).

Further, all (100%) of the second binary data is recorded during the second scanning operation. In other words, while the recording element group performs three scanning operations sequentially, both of the first binary data and the second binary data are entirely (100%) recorded in the upper one-third part of the recording area (C). The recording element group performs similar operations for the central one-third part and the lower one-third part of the recording area (C).

Realizing the above-described method using the configuration of the above-described exemplary embodiment is feasible. However, in this case, to generate binary data dedicated to each scanning operation of the recording element group, it is necessary to switch the print buffer to be referred to according to the position (i.e., the area) of the recording element group. For example, in the first scanning operation (see (a)), it is necessary to refer to the first binary data (i.e., the first plane) storage area of the print buffer for the upper end portion (a1) and the lower end portion (a3) of the recording element group. Further, it is necessary to refer to the second binary data (i.e., the second plane) storage area of the print buffer for the central portion (a2) of the recording element group.

According to the conventional method, as illustrated in FIGS. 15 and 16, the same print buffer is referred to when binary data dedicated to the same scanning operation is generated. Therefore, it is necessary to add a configuration capable of changing a reference destination of the print buffer according to the position (i.e., the area) of the recording element group. Hence, in the present modified embodiment, the above-described problem can be solved by employing the following data management method.

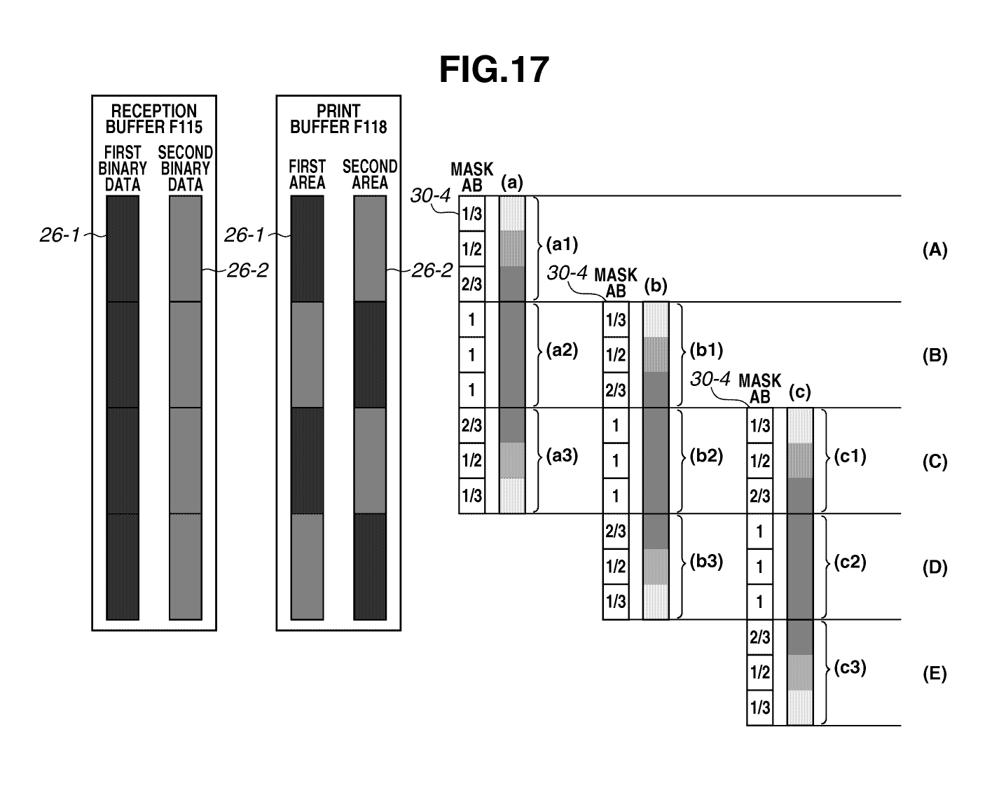

FIG. 17 illustrates a binary data management method according to the present modified embodiment. In the present modified embodiment, binary data constituting two planes (i.e., first binary data and second binary data) are input to the reception buffer F115. Next, the binary data constituting two planes is transferred from the reception buffer F115 to the print buffer F118.

The data management method according to the present modified embodiment is characterized in that, when the data is transfer from the reception buffer to the print buffer, the first plane binary data (i.e., the first binary data) and the second plane binary data (i.e., the second binary data) of the reception buffer are alternately stored in a first area and a second area of the print buffer. More specifically, instead of managing binary data having been processed on a plurality of planes (i.e., binary data corresponding to the pass number) for each plane, the binary data is stored and managed in the print buffer in association with each scanning operation of the recording element group.

The above-described data transfer can be performed by designating an address of the reception buffer of the transfer source, an address of the print buffer of the transfer destination, and an amount of data to be transferred. Therefore, alternately storing the first plane binary data and the second plane binary data in each area of the print buffer can be easily realized by alternately setting the address of the transfer source between the first plane and the second plane of the reception buffer.

Next, the first scanning binary data (a) of the recording element group can be generated based on AND calculation between the binary data stored in the first area of the print buffer F118 and a mask AB (30-4). In this case, the mask AB includes a mask B (30-2) positioned in an area that corresponds to the upper end portion of the recording element group. A central portion of the mask AB is constituted by a mask pattern having a recording admission rate of 100%, which permits recording for all pixels. Further, the mask AB includes a mask A (30-1) positioned in an area that corresponds to the lower end portion of the recording element group.

Next, the second scanning binary data (b) of the recording element group can be generated based on AND calculation between the binary data stored in the second area of the print buffer F118 and the mask AB (30-4). Then, the third scanning binary data (c) can be generated based on AND calculation between the binary data stored in the first area of the print buffer F118 and the mask AB (30-4), again.

As described above, in the present modified embodiment, when the first binary data and the second binary data are transferred from the reception buffer to the print buffer, the first binary data and the second binary data are alternately stored in the different areas of the print buffer. Further, as the mask pattern (mask AB) applicable to the whole part of the recording element group is employed, binary data dedicated to each scanning operation can be generated referring to the same print buffer. Therefore, the present modified embodiment does not require a complicated configuration to generate the binary data dedicated to each scanning operation of the recording element group from the binary data constituting a plurality of planes.

A fourth exemplary embodiment relates to a 5-pass recording method for completing an image in the same area of a recording medium through five scanning and recording operations. The 5-pass recording method includes generating two pieces of multi-valued data, performing quantization processing on each generated multi-valued data, and dividing each binary data into two or three so as to reduce the data processing load. Further, the fourth exemplary embodiment can prevent an image from containing a defective part, such as a streak, by setting the recording duty at an edge portion of a recording element group to be lower than the recording duty at a central portion of the recording element group.

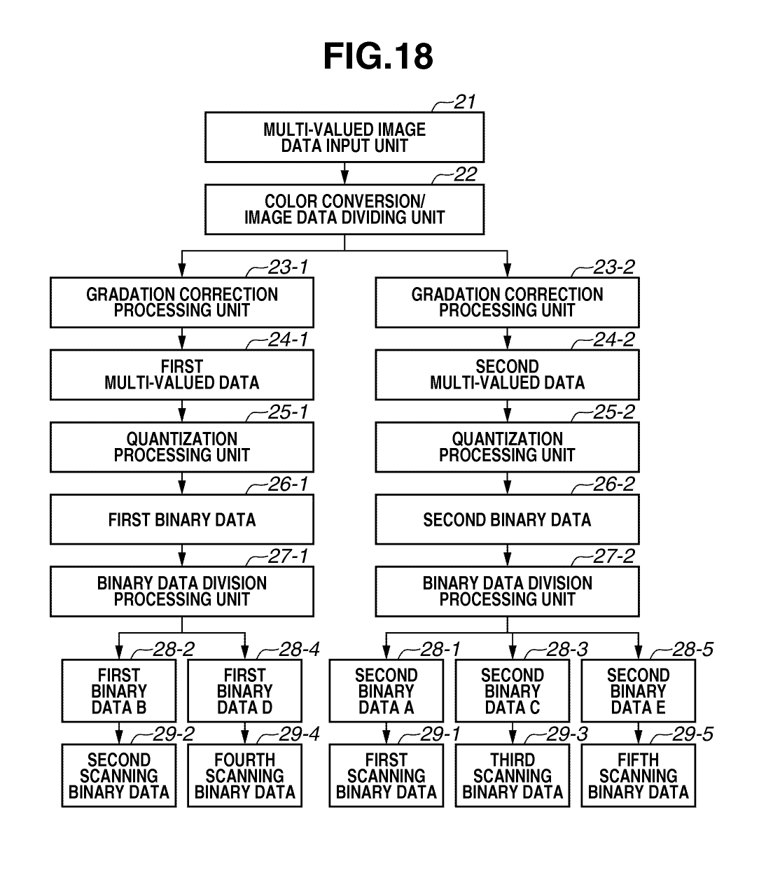

FIG. 18 is a block diagram illustrating example image processing according to the present exemplary embodiment, in which the 5-pass recording processing is performed. In FIG. 18, processing in each step according to the present exemplary embodiment is basically similar to the processing in a corresponding step of the image processing described in the first exemplary embodiment illustrated in FIG. 21.

In FIG. 18, the multi-valued image data input unit 21 inputs RGB multi-valued image data (256 values) from an external device. The color conversion/image data dividing unit 22 converts the input image data (multi-valued RGB data), for each pixel, into two sets of multi-valued image data (CMYK data) of first recording density multi-valued data and second recording density multi-valued data corresponding to each ink color.

Next, the gradation correction processing units 23-1 and 23-2 perform gradation correction processing on the first multi-valued data and the second multi-valued data, for each color. Then, first multi-valued data 24-1 (C1′, M1′, Y1′, K1′) and second multi-valued data 24-2 (C2′, M2′, Y2′, K2′) can be obtained from the first multi-valued data and the second multi-valued data.

The subsequent processing is independently performed for each of cyan (C), magenta (M), yellow (Y), and black (K) colors in parallel with each other, although the following description is limited to only the black (K) color.

Subsequently, the quantization processing units 25-1 and 25-2 perform independent binarization processing (i.e., quantization processing) on the first multi-valued data 24-1 (K1′) and the second multi-valued data 24-2 (K2′), non-correlatively. More specifically, the quantization processing unit 25-1 performs error diffusion processing on the first multi-valued data 24-1 (K1′) using the error diffusion matrix illustrated in FIG. 13A and a predetermined quantization threshold, and generates first binary data K1″ (first quantized data) 26-1.

Further, the quantization processing unit 25-2 performs error diffusion processing on the second multi-valued data 24-2 (K2′) using the error diffusion matrix illustrated in FIG. 13B and a predetermined quantization threshold, and generates second binary data K2″ (second quantized data) 26-2.

If the binary image data K1″ and K2″ can be obtained by the quantization processing units 25-1 and 25-2 as described above, these data K1″ and K2″ are respectively transmitted to the printer engine 3004 via the IEEE1284 bus 3022 as illustrated in FIG. 3. The printer engine 3004 performs the subsequent processing.

In this case, a method for dividing data into the first binary data and the second binary data and a method for allocating the divided first binary data and the second binary data to data corresponding to respective scanning operations are different from the methods described in the first exemplary embodiment.

First, the binary data division processing unit 27-1 divides the first binary image data K1″ (26-1) into first binary data B (28-2) and first binary data D (28-4). Further, the binary data division processing unit 27-2 divides the second binary image data K1″ (26-2) into second binary data A (28-1), second binary data C (28-3), and second binary data E (28-5). Then, the first binary data B (28-2) is allocated, as second scanning binary data 29-2, to the second scanning operation. The first binary data D (28-4) is allocated, as fourth scanning binary data 29-4, to the fourth scanning operation. The second scanning binary data 29-2 and the fourth scanning binary data 29-4 are recorded in the second and fourth scanning operations.

Further, the second binary data A (28-1) is allocated, as first scanning binary data 29-1, to the first scanning operation. The second binary data C (28-3) is allocated, as third scanning binary data 29-3, to the third scanning operation. Further, the second binary data E (28-5) is allocated, as fifth scanning binary data 29-5, to the fifth scanning operation. The first scanning binary data 29-1, the third scanning binary data 29-3, and the fifth scanning binary data 29-5 are recorded in the first, third, and fifth scanning operations.

In the present exemplary embodiment, the input image data is separated into the first multi-valued image data and the second multi-valued image data at the ratio of 6:8. Then, the binary data dividing unit 27-1 uniformly divides the first binary data into two pieces of data with appropriate mask patterns to generate the first binary data B (28-2) and the first binary data D (28-4). In other words, each of the generated first binary data B (28-2) and the first binary data D (28-4) is generated as binary data having a recording duty of “3/14.”

On the other hand, the binary data dividing unit 27-2 divides the second binary data into three pieces of data with appropriate mask patterns to generate the second binary data A (28-1), the second binary data C (28-3), and the second binary data E (28-5). In this case, the second binary data A (28-1), the second binary data C (28-3), and the second binary data E (28-5) are in a division ratio of 1:2:1 with respect to the recording duty ratio.

More specifically, as the recording duty of the second binary data 27-2 is “8/14”, the second binary data A (28-1) is generated as binary data having a recording duty of “2/14.” The second binary data C (28-3) is generated as binary data having a recording duty of “4/14.” The second binary data E (28-5) is generated as binary data having a recording duty of “2/14.”

In the present exemplary embodiment, the second binary data A, the first binary data B, the second binary data C, the first binary data D, and the second binary data E are allocated, in the order of, to sequential scanning operations. Therefore, the recording duty of respective areas of the recording element group become “2/14”, “3/14”, “4/14”, “3/14”, and “2/14” from one end to the other end. Accordingly, it becomes feasible to set the recording duty at an edge portion of the recording element group to be lower than the recording duty at a central portion thereof. More specifically, the present exemplary embodiment can reduce the data processing load and can prevent an image from containing a defective part, such as a streak, by applying the dot overlapping control to only a part of the scanning operations.

However, according to a bidirectional recording method that causes a recording element group to perform recording in both the forward relative movement and the rearward relative movement, recording positions may deviate between a scanning operation in the forward direction and a scanning operation in the rearward direction. Accordingly, for example, it is feasible to suppress the density variation by allocating the first binary data to a forward scanning operation and allocating the second binary data to a rearward scanning operation, because there are some dots overlapped between the first binary data and the second binary data, even when the deviation in the recording position occurs between the forward scanning operation and the rearward scanning operation.

For example, although the first and second exemplary embodiments have been described based on the 3-pass recording method, if the recording is performed according to a bidirectional 3-pass recording method, the scanning direction relative to the same recording area in the first and third scanning operations is different from the scanning direction in the second scanning operation. Therefore, as described in the first and second exemplary embodiments, the deviation in the recording position between a forward scanning operation and a rearward scanning operation according to the bidirectional recording method can be reduced by allocating the first binary data A and the first binary data B (i.e., the binary data divided from the first binary data with mask patterns) to the first scanning operation and the third scanning and further allocating the second binary data to the second scanning operation.

In other words, from the viewpoint of reducing the influence of a deviation in the recording position in the bidirectional recording method, it is desired to allocate quantized data divided using the mask patterns to the scanning operations to be performed in the same direction. More specifically, it is feasible to allocate the quantized data divided using the mask patterns to the scanning operations to be performed in the same direction by allocating quantized division data generated from the quantized data largest in the division number, among N pieces of quantized data, to the scanning operations performed in the same directions.

For example, in the first and second exemplary embodiments, the division number of the first binary data is 2 and the division number of the second binary data is zero. Then, it is feasible to reduce the influence of a deviation in recording position in the bidirectional recording method by allocating the first binary data A and B (i.e., the binary data divided from the first binary data that is larger in the division number) to the scanning operations performed in the same direction.

If the division number is greater than the number of scanning operations performed in the same direction, it is desired to allocate a part of quantized division data to the scanning operations performed in the same direction in such a way as to allocate quantized division data generated using the mask patterns to all scanning operations performed in the same direction.

Further, although the above-described exemplary embodiments have been described based on black (K) data, it is needless to say that similar processing can be performed on any other color data. Alternatively, the processing according to the present invention can be applied to only specific colors that are greatly influenced by deviations in the recording position. For example, the conventional method can be applied to yellow (Y) data because the influence of a deviation in the recording position is small. More specifically, according to the conventional method, quantization processing is applied to multi-valued data corresponding to a plurality of scanning operations to generate binary data and the generated binary data is divided into binary data corresponding to a plurality of scanning operations. Further, the method according to any one of the above-described first to fourth exemplary embodiments can be applied to cyan (C), magenta (M), and black (K) data.

Further, in a case where the recording is performed using a plurality of ink droplets that are different in dot diameter (e.g., larger dots and smaller dots), the conventional method including quantization of multi-valued data to generate binary data and division of the generated binary data for a plurality of scanning operations can be applied to only the smaller dots that are not so influenced by a deviation in the recording position. Further, the method according to any one of the above-described first to fourth exemplary embodiments can be applied to the larger dots that are greatly influenced by a deviation in the recording position.

Further, in a case where the recording is performed using a plurality of ink droplets that are different in ink density (e.g., dark inks and light inks), the conventional method including quantization of multi-valued data to generate binary data and division of the generated binary data for a plurality of scanning operations can be applied to only the light inks that are not so influenced by a deviation in the recording position. Further, the method according to any one of the above-described first to fourth exemplary embodiments can be applied to the dark inks that are greatly influenced by a deviation in the recording position.

Further, in a case where the recording is performed using a plurality of recording quality levels that are different in the pass number of the multi-pass recording operation (e.g., a fast mode (or a low pass mode) and a fine mode (or a high pass mode)), the conveyance accuracy of a recording medium becomes higher when a large pass number is selected because the conveyance amount per step is small. Accordingly, the conventional method including quantization of multi-valued data to generate binary data and division of the generated binary data for a plurality of scanning operations can be applied to only the fine mode that is not so influenced by a deviation in the recording position. Further, the method according to any one of the above-described first to fourth exemplary embodiments can be applied to the fast mode that is low in the conveyance accuracy of a recording medium and is greatly influenced by a deviation in the recording position.

Further, in a case where the recording is performed using a plurality of recording media that are different in quality (e.g., glossy papers and mat papers), the conventional method including quantization of multi-valued data to generate binary data and division of the generated binary data for a plurality of scanning operations can be applied to only the mat papers that are high in the recording medium bleeding rate and are not so influenced by a deviation in the recording position. Further, the method according to any one of the above-described first to fourth exemplary embodiments can be applied to the glossy papers that are low in the recording medium bleeding rate and are greatly influenced by a deviation in the recording position.

Further, in the above-described first to fourth exemplary embodiments, if the number of ink colors is large or a plurality of ink droplets that are different in size are used when the mask processing is performed on the first binary data and the second binary data, the mask pattern can be changed for each color or for each ink droplet. In this case, it is desired that mask patterns are effectively set for respective colors or for respective ink droplets so that the overlapping rate becomes lower compared to the probable dot overlapping rate.

For example, the mask A and the mask B that are in the mutually exclusive relationship may be applied to the cyan and magenta data. In this case, for the cyan data, the first scanning data can be generated based on AND calculation between the binary data and the mask A and the second scanning data can be generated based on AND calculation between the binary data and the mask B. On the other hand, for the magenta data, the first scanning data can be generated based on AND calculation between the binary data and the mask B and the second scanning data can be generated based on AND calculation between the binary data and the mask A. Accordingly, it becomes feasible to prevent the dot overlapping rate from changing before and after the occurrence of a deviation in the recording position. It becomes feasible to effectively suppress a density variation that may occur due to a deviation in the recording position.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-144212 filed Jun. 24, 2010, which is hereby incorporated by reference herein in its entirety.

What is claimed is:

1. An image processing apparatus that can process input image data corresponding to an image to be recorded in a predetermined area of a recording medium through M (M being an integer equal to or greater than 3) relative movements between a recording element group configured to discharge a same color ink and the recording medium, the image processing apparatus comprising:
a first generation unit configured to generate N (N being an integer equal to or greater than 2 and smaller than M) pieces of same color multi-valued image data from the input image data;
a second generation unit configured to generate the N pieces of quantized data by performing quantization processing on the N pieces of the same color multi-valued image data generated by the first generation unit; and
a third generation unit configured to divide at least one piece of quantized data, among the N pieces of quantized data generated by the second generation unit, into a plurality of quantized data and generate M pieces of quantized data corresponding to the M relative movements,
wherein the M pieces of quantized data includes quantized data corresponding to an edge portion of the recording element group and quantized data corresponding to a central portion of the recording element group, and a recording duty of the quantized data corresponding to the edge portion is set to be lower than a recording duty of the quantized data corresponding to the central portion.

2. The image processing apparatus according to claim 1, wherein the N pieces of quantized data includes quantized data divided by the third generation unit and quantized data not divided by the third generation unit, and a recording duty of the divided quantized data is set to be higher than a recording duty of the non-divided quantized data.

3. The image processing apparatus according to claim 1, wherein a part or the whole of the quantized data that is larger in the number of quantized data divided by the third generation unit, among the N pieces of quantized data, is designated as quantized data corresponding to scanning operations performed in the same direction.

4. The image processing apparatus according to claim 1, wherein the integer N is equal to 2.

5. The image processing apparatus according to claim 1, wherein the third generation unit divides one of two pieces of quantized data into quantized data corresponding to two relative movements and does not divide the other of two pieces of quantized data.

6. The image processing apparatus according to claim 1, wherein the first generation unit, the second generation unit, and the third generation unit perform the processing for generating the M pieces of quantized data corresponding to the M relative movements for each ink color.

7. The image processing apparatus according to claim 1, wherein the first generation unit, the second generation unit, and the third generation unit perform the processing for generating the M pieces of quantized data corresponding to the M relative movements according to an ink density.

8. The image processing apparatus according to claim 1, wherein the first generation unit, the second generation unit, and the third generation unit perform the processing for generating the M pieces of quantized data corresponding to the M relative movements according to an ink dot diameter.

9. An image processing method for processing input image data corresponding to an image to be recorded in a predetermined area of a recording medium through M (M being an integer equal to or greater than 3) relative movements between a recording element group configured to discharge a same color ink and the recording medium, the image processing method comprising:
generating N (N being an integer equal to or greater than 2 and smaller than M) pieces of same color multi-valued image data from the input image data;
generating the N pieces of quantized data by performing quantization processing on the generated N pieces of the same color multi-valued image data; and
dividing at least one piece of quantized data, among the generated N pieces of quantized data, into a plurality of quantized data and generating M pieces of quantized data corresponding to the M relative movements,
wherein the M pieces of quantized data includes quantized data corresponding to an edge portion of the recording element group and quantized data corresponding to a central portion of the recording element group, and a recording duty of the quantized data corresponding to the edge portion is set to be lower than a recording duty of the quantized data corresponding to the central portion.

10. A recording apparatus that can record an image in a predetermined area of a recording medium through M (M being an integer equal to or greater than 3) relative movements between a recording element group configured to discharge a same color ink and the recording medium, the recording apparatus comprising:
a first generation unit configured to generate N (N being an integer equal to or greater than 2 and smaller than M) pieces of same color multi-valued image data from the input image data corresponding to the image to be recorded in the predetermined area;
a second generation unit configured to generate the N pieces of quantized data by performing quantization processing on the N pieces of the same color multi-valued image data generated by the first generation unit; and
a third generation unit configured to divide at least one piece of quantized data, among the N pieces of quantized data generated by the second generation unit, into a plurality of quantized data and generate M pieces of quantized data corresponding to the M relative movements,
wherein the M pieces of quantized data includes quantized data corresponding to an edge portion of the recording element group and quantized data corresponding to a central portion of the recording element group, and a recording duty of the quantized data corresponding to the edge portion is set to be lower than a recording duty of the quantized data corresponding to the central portion.

11. The recording apparatus according to claim 10, further comprising:
a storing unit configured to store the M pieces of quantized data, and
a driving unit configured to drive the recording element group based on the M pieces of quantized data stored in the storing unit,
wherein the M pieces of quantized data is stored in the storing unit in association with each relative movement of the recording element group.
